(19) United States
(12) Patent Application Publication
(10) Pub. No.: US 2026/0280826 A1
(43) Pub. Date: Sep. 17, 2026

(54) METHOD, USER EQUIPMENT AND ACCESS NETWORK NODE

(71) Applicant: NEC Corporation, Tokyo (JP)

(72) Inventors: Xuelong WANG, Guildford (GB); Caroline Quanyi LIANG, Guildford (GB); Pravjyot DEOGUN, Milton Keynes (GB)

(73) Assignee: NEC Corporation, Tokyo (JP)

(21) Appl. No.: 19/471,417

(22) PCT Filed: Mar. 29, 2024
(86) PCT No.: PCT/JP2024/013118

§ 371 Date: Oct. 1, 2025

(30) Foreign Application Priority Data
Apr. 14, 2023 (GB) 2305562.7

(51) Int. Cl. H04L 5/00; H04W 52/02; H04W 72/232; H04W 72/541; H04W 72/542

(52) U.S. Cl. CPC H04L 5/0094; H04W 52/0206; H04W 72/232; H04W 72/541; H04W 72/542

(57) ABSTRACT

The present disclosure relates to a method performed by a mobile device, the method including: receiving, from an access network node, report configuration information including a plurality of sub-configurations indicating at least one of: spatial domain adaptation patterns each of which corresponds to a subset of available spatial elements configured by the report configuration information, or power offsets each of which corresponds to a power offset value between a physical downlink shared channel (PDSCH) and a reference signal; performing a measurement of one or more reference signals; and transmitting, to the access network node, a measurement report using a transition time specific to the plurality of the sub-configuration.

### TECHNICAL FIELD

The present disclosure relates to a communication system.

### BACKGROUND ART

The disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The disclosure has particular, although not necessarily exclusive, relevance to network energy saving (NES) in ‘New Radio’ systems (also referred to as ‘Next Generation’ systems), and similar systems.

Recent developments of the 3GPP standards are referred to as the Long-Term Evolution (LTE) of Evolved Packet Core (EPC) network and Evolved UMTS Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the radio access network (RAN) node (or simply ‘access node’, ‘access network node’ or ‘base station’) via which communication devices (user equipment or ‘UE’) connect to a core network and communicate with other communication devices or remote servers. For simplicity, the present application will use the term RAN node, base station, or access network node to refer to any such access nodes.

There is a need for improved wireless communication networks having improved energy efficiency (sometimes referred to as using Network Energy Saving, NES, techniques). A reduction in the amount of energy needed to operate a communication network beneficially reduces the environmental impact of operating the system, and also reduces the operational costs. For example, the energy consumption of base stations and other similar access network nodes represents a major operational expenditure for network operators, in addition to presenting concerns with respect to the environmental impacts of operating telecommunications networks. There are various tools to save energy at the network side. For example, energy saving can be achieved by considering the transmissions in the network in spatial domain (e.g. more efficient use of spatial elements such as antenna ports) and in the power domain (e.g. by reducing transmission powers).

### CITATION LIST

### Patent Literature

PTL 1: WO2023/050312A1
PTL 2: US2018/0375560A1

### Non Patent Literature

NPL 1: The ‘NGMN 5G White Paper’ V1.0 by the Next Generation Mobile Networks (NGMN) Alliance, available from https://www.ngmn.org/5g-white-paper.html.

### SUMMARY OF INVENTION

### Technical Problem

By disabling spatial elements and/or reduce transmission powers or power spectrum density, the energy efficiency of the system can be improved. However, the system performance may be degraded as the amount of energy saving is increased. For example, if the number of antennas for transmission of a reference signal (e.g. channel state information reference signal, CSI-RS) is reduced, the transmission power will decrease, and a UE at the edge of the cell may not be able to detect the reference signal resulting in degradation of the communication quality or performance.

Improved apparatus and methods for network energy saving whilst providing reliable and efficient communication are therefore needed. For example, improved apparatus and methods for enabling a UE to reliably receive reference signals in a cell of a base station that performs a method for energy saving in the spatial or power domains are needed.

### Solution to Problem

In one aspect the disclosure provides a method performed by an access network node, the method comprising: transmitting, to a user equipment, UE, in a cell provided by the access network node, report configuration information comprising an indication of one or more reference signal resources for measurement of a reference signal by the UE; wherein each of the one or more reference signal resources is associated with a respective one of a set of energy saving configurations for transmission of the reference signal by the access network node; and wherein the method further comprises: transmitting the reference signal; and receiving, from the UE, a measurement report generated based on the report configuration information.

The set of energy saving configurations may comprises: a set of power levels for transmission of the reference signal by the access network node; or a set of spatial configurations for transmission of the reference signal by the access network node.

The report configuration information may comprise an indication of one or both of: a spatial configuration for transmission of the reference signal by the access network node; or a reference signal pattern or reference signal measurement resource associated with the spatial configuration.

Each spatial configuration may correspond to a respective set of antenna elements for transmission of the reference signal by the access network node.

The report configuration information may comprise an index that indicates at least one of the spatial configuration or the respective reference signal resources.

The method may further comprise transmitting, to the UE, downlink control information, DCI, comprising the index.

The method may further comprise transmitting, to the UE, a table that provides an indication of a mapping between the index and at least one of: the corresponding spatial configuration for transmission of the reference signal by the access network node; or the corresponding reference signal resources.

The one or more reference signal resources may comprise at least one of: one or more non-zero power, NZP, channel state information reference signal, CSI-RS, measurement resources; one or more CSI interference measurement, IM, resources; or one or more NZP CSI-RS resources.

The method may comprise transmitting the report configuration information to the UE as part of: network energy saving, NES, configuration information; a channel state information, CSI, report configuration; radio resource control, RRC, reconfiguration information; or system information broadcast in the cell.

The reference signal may be a CSI-RS, and the access network node may transmit the report configuration information to the UE in a CSI report configuration.

The reference signal resources may correspond to CSI-RS measurement resources.

The report configuration information may comprises at least one of: an indication of a plurality of resources for measurement of a channel; or an indication of a plurality of resources for interference measurement; wherein each of the resources for measurement of a channel or the resources for interference measurement are associated with a respective spatial configuration for transmission of the reference signal by the access network node.

In another aspect the disclosure provides a method performed by a user equipment, UE, the method comprising: receiving, from an access network node, report configuration information comprising an indication of one or more reference signal resources for measurement of a reference signal by the UE; wherein each of the one or more reference signal resources is associated with a respective one of a set of energy saving configurations for transmission of the reference signal by the access network node; and wherein the method further comprises: performing a measurement of the reference signal; and transmitting, to the access network node, a measurement report generated based on the report configuration information.

The set of energy saving configurations may comprise: a set of power levels for transmission of the reference signal by the access network node; or a set of spatial configurations for transmission of the reference signal by the access network node.

The report configuration information may comprise an indication of one or both of: a spatial configuration for transmission of the reference signal by the access network node; or a reference signal pattern or reference signal measurement resource associated with the spatial configuration.

B4. The method according to claim B2 or B3, wherein each spatial configuration corresponds to a respective set of antenna elements for transmission of the reference signal by the access network node.

The report configuration information may comprise an index that indicates at least one of the spatial configuration or the respective reference signal resources.

The method may further comprise receiving, from the access network node, downlink control information, DCI, comprising the index.

The method may further comprise receiving, from the access network node, a table that provides an indication of a mapping between the index and at least one of: the corresponding spatial configuration for transmission of the reference signal by the access network node; or the corresponding reference signal resources.

The one or more reference signal resources may comprise at least one of: one or more non-zero power, NZP, channel state information reference signal, CSI-RS, measurement resources; one or more CSI interference measurement, IM, resources; or one or more NZP CSI-RS resources.

The method may comprise receiving the report configuration information from the access network node as part of: network energy saving, NES, configuration information; a channel state information, CSI, report configuration; radio resource control, RRC, reconfiguration information; or system information broadcast in the cell.

The reference signal may be a CSI-RS, and the UE may receive the report configuration information from the access network node in a CSI report configuration.

The reference signal resources may correspond to CSI-RS measurement resources.

The report configuration information may comprise at least one of: an indication of a plurality of resources for measurement of a channel; or an indication of a plurality of resources for interference measurement; wherein each of the resources for measurement of a channel or the resources for interference measurement are associated with a respective spatial configuration for transmission of the reference signal by the access network node.

The measurement report transmitted to the access network node may comprise an indication of one or more CSI; and an indication of the of energy saving configuration associated with each of the one or more CSI.

In another aspect the disclosure provides a method of an access network node, the method comprising: transmitting, to a user equipment, UE, in a cell provided by the access network node, report configuration information comprising an indication of a number of channel state information, CSI, or signal to interference and noise ratio, SINR, values to be included in a measurement report to be transmitted to the access network node by the UE; wherein each of the CSI or SINR values is associated with a respective one of a set of energy saving configurations for transmission of a reference signal by the access network node;

and wherein the method further comprises: receiving, from the UE, a measurement report generated based on the report configuration information.

The set of energy saving configurations may comprise: a set of power levels for transmission of the reference signal by the access network node; or a set of spatial configurations for transmission of the reference signal by the access network node.

Each spatial configuration corresponds to a respective set of antenna elements for transmission of the reference signal by the access network node.

The measurement report received from the UE may comprise an indication of the energy saving configuration associated with each CSI or SINR value included in the measurement report.

The measurement report may include: an indication of a first CSI or SINR value, indicated using a first number of bits; and an indication of a second CSI or SINR value, indicated using a second number of bits; wherein the second number of bits is smaller than the first number of bits; and wherein the second CSI or SINR value is indicated by indicating a difference between the second CSI or SINR value and the first CSI or SINR value.

The measurement report may include an indication of a first CSI or SINR value, indicated using a first number of bits; wherein the first CSI or SINR value is associated with an energy saving configuration for transmission of the reference signal by the access network node; and wherein the first CSI or SINR value is indicated by indicating a difference between the first CSI or SINR value and a CSI or SINR value associated with a reference signal transmitted by the base station before the base station transmitted the reference signal using the energy saving configuration.

In another aspect the disclosure provides a method of user equipment, UE, the method comprising: receiving, from an access network node, report configuration information comprising an indication of a number of channel state information,

CSI, or signal to interference and noise ratio, SINR, values to be included in a measurement report to be transmitted to the access network node by the UE; wherein each of the CSI or SINR values is associated with a respective one of a set of energy saving configurations for transmission of a reference signal by the access network node; and wherein the method further comprises: transmitting, to the access network node, a measurement report generated based on the report configuration information.

The set of energy saving configurations may comprise: a set of power levels for transmission of the reference signal by the access network node; or a set of spatial configurations for transmission of the reference signal by the access network node.

Each spatial configuration may correspond to a respective set of antenna elements for transmission of the reference signal by the access network node.

The measurement report transmitted to the access network node by the UE may comprise an indication of the energy saving configuration associated with each CSI or SINR value included in the measurement report.

The method may further comprise determining the CSI or SINR value to include in the measurement report for transmitting to the access network node.

The measurement report may include: an indication of a first CSI or SINR value, indicated using a first number of bits; and an indication of a second CSI or

SINR value, indicated using a second number of bits; wherein the second number of bits is smaller than the first number of bits; and wherein the second CSI or SINR value is indicated by indicating a difference between the second CSI or SINR value and the first CSI or SINR value.

The measurement report may include an indication of a first CSI or SINR value, indicated using a first number of bits; wherein the first CSI or SINR value is associated with an energy saving configuration for transmission of the reference signal by the access network node; and wherein the first CSI or SINR value is indicated by indicating a different between the first CSI or SINR value and a CSI or SINR value associated with a reference signal transmitted by the base station before the base station transmitted the reference signal using the energy saving configuration.

In another aspect the disclosure provides a method performed by an access network node, the method comprising: transmitting, to a user equipment, UE, in a cell provided by the access network node, energy saving configuration information comprising an indication of one or more energy saving configurations for transmission of a reference signal by the access network node; and receiving, from the UE, UE capability information comprising an indication of one or more transition times, wherein each transition time corresponds to a time duration for the UE to transition a state in which the UE is configured for measuring the reference signal transmitted by the access network node based on a respective one of the one or more energy saving configurations.

The set of energy saving configurations may comprise: a set of power levels for transmission of the reference signal by the access network node; or a set of spatial configurations for transmission of the reference signal by the access network node.

Each spatial configuration may correspond to a respective set of antenna elements for transmission of the reference signal by the access network node.

In another aspect the disclosure provides a method performed by a user equipment, UE, the method comprising: receiving, from an access network node, energy saving configuration information comprising an indication one or more energy saving configurations for transmission of a reference signal by the access network node; and transmitting, to the access network node, UE capability information comprising an indication of one or more transition times, wherein each transition time corresponds to a time duration for the UE to transition a state in which the UE is configured for measuring the reference signal transmitted by the access network node based on a respective one of the one or more energy saving configurations.

In another aspect the disclosure provides a method performed by an access network node, the method comprising: transmitting, to a user equipment, UE, in a cell provided by the access network node, transmission configuration information comprising an indication of one or more energy saving configurations for transmission of a reference signal or a physical downlink shared channel, PDSCH, by the access network node; and transmitting the reference signal or the PDSCH; wherein the transmission configuration information comprises at least one of: an indication of a power offset used for transmission of the reference signal or the PDSCH; or an indication of a spatial configuration used for transmission the reference signal or the PDSCH.

The spatial configuration may correspond to a configuration of set of antenna elements for transmission of the reference signal or the PDSCH by the access network node.

The indication of one or more energy saving configurations for transmission of the reference signal or the PDSCH may comprise an index that indicates one or both of the power offset used for transmission of the reference signal or the PDSCH, or the spatial configuration used for transmission the reference signal or the PDSCH.

The index may be associated with one or more corresponding lookup tables that provide a mapping between one or both of: the value of the index and the power offset used for transmission of the reference signal or the PDSCH; the value of the index and the spatial configuration used for transmission the reference signal.

In another aspect the disclosure provides a method performed by a user equipment, UE, the method comprising: receiving, from an access network node, transmission configuration information comprising an indication of one or more energy saving configurations for transmission of a reference signal or a physical downlink shared channel, PDSCH, by the access network node; and receiving the reference signal or the PDSCH; wherein the transmission configuration information comprises at least one of: an indication of a power offset used for transmission of the reference signal or the PDSCH by the access network node; or an indication of a spatial configuration used for transmission the reference signal or the PDSCH by the access network node.

The spatial configuration may correspond to a configuration of set of antenna elements for transmission of the reference signal or the PDSCH by the access network node.

The indication of one or more energy saving configurations for transmission of the reference signal or the PDSCH may comprise an index that indicates one or both of the power offset used for transmission of the reference signal or the PDSCH, or the spatial configuration used for transmission the reference signal or the PDSCH.

The index may be associated with one or more corresponding lookup tables that provide a mapping between one or both of: the value of the index and the power offset used for transmission of the reference signal or the PDSCH; or the value of the index and the spatial configuration used for transmission the reference signal.

The method may further comprise obtaining the one or more lookup tables.

In another aspect the disclosure provides a method performed by an access network node, the method comprising: transmitting, to a user equipment, UE, in a cell provided by the access network node, downlink control information, DCI, or downlink grant information comprising an indication of an energy saving configuration for transmission of a physical downlink shared channel, PDSCH, by the access network node; wherein the DCI or downlink grant information comprises an indication of a time after which the UE is to use the indicated energy saving configuration to perform configuration for receiving the PDSCH; and the method further comprises transmitting the PDSCH using the energy saving configuration.

The energy saving configuration may comprise: a power level or power offset for transmission of the PDSCH by the access network node; or a spatial configuration for transmission of the PDSCH by the access network node.

The spatial configuration may correspond to a configuration of antenna elements for transmission of the PDSCH by the access network node.

The DCI may be group common DCI transmitted to a plurality of UEs by the access network node.

The DCI may be group common DCI, and the method may comprise transmitting, to the UE, an indication of a transmission configuration indicator, TCI, state associated with the PDSCH for which the UE is to use the indicated energy saving configuration to perform configuration for receiving the PDSCH.

The method may comprise transmitting, to the UE, an indication of a TCI state to indicate the energy saving configuration.

In another aspect the disclosure provides a method performed by a user equipment, UE, the method comprising: receiving, from an access network node, downlink control information, DCI, or downlink grant information comprising an indication of an energy saving configuration for transmission of a physical downlink shared channel, PDSCH, by the access network node; wherein the DCI or downlink grant information comprises an indication of a time after which the UE is to use the indicated energy saving configuration to perform configuration for receiving the PDSCH, or the time after which the UE is to use the indicated energy saving configuration to perform configuration for receiving the PDSCH is preconfigured at the UE; and wherein the method further comprises performing the configuration for receiving the PDSCH after the indicated time, and receiving the PDSCH.

The energy saving configuration may comprises: a power level or power offset for transmission of the PDSCH by the access network node; or a spatial configuration for transmission of the PDSCH by the access network node.

The spatial configuration may correspond to a configuration of antenna elements for transmission of the PDSCH by the access network node.

The DCI or downlink grant information may comprise an indication of a scheduled PDSCH, wherein the UE only uses the indicated energy saving configuration to perform configuration for receiving the scheduled PDSCH.

The DCI or downlink grant information may comprise an indication of one or more PDSCH for which the UE is to use the indicated energy saving configuration to perform configuration for receiving the one or more PDSCH, wherein the UE only uses the indicated energy saving configuration to perform configuration for receiving the indicated one or more PDSCH.

The DCI may be a group common DCI transmitted to a plurality of UEs.

The UE may only use the indicated energy saving configuration to perform configuration for receiving the scheduled PDSCH associated with a particular transmission configuration indicator, TCI, state.

The DCI may be group common DCI, and the method may comprise receiving, from the access network node, an indication of a TCI state associated with the PDSCH for which the UE is to use the indicated energy saving configuration to perform configuration for receiving the PDSCH.

The method may comprise receiving, from the access network node, an indication of a TCI state, and determining the energy saving configuration based on the indicated TCI state.

In another aspect the disclosure provides an access network node comprising: means for transmitting, to a user equipment, UE, in a cell provided by the access network node, report configuration information comprising an indication of one or more reference signal resources for measurement of a reference signal by the UE, wherein each of the one or more reference signal resources is associated with a respective one of a set of energy saving configurations for transmission of the reference signal by the access network node; means for transmitting the reference signal; and means for receiving, from the UE, a measurement report generated based on the report configuration information.

In another aspect the disclosure provides a user equipment, UE, comprising: means for receiving, from an access network node, report configuration information comprising an indication of one or more reference signal resources for measurement of a reference signal by the UE, wherein each of the one or more reference signal resources is associated with a respective one of a set of energy saving configurations for transmission of the reference signal by the access network node; means for performing a measurement of the reference signal; and means for transmitting, to the access network node, a measurement report generated based on the report configuration information.

In another aspect the disclosure provides an access network node comprising: means for transmitting, to a user equipment, UE, in a cell provided by the access network node, report configuration information comprising an indication of a number of channel state information, CSI, or signal to interference and noise ratio, SINR, values to be included in a measurement report to be transmitted to the access network node by the UE; wherein each of the CSI or SINR values is associated with a respective one of a set of energy saving configurations for transmission of a reference signal by the access network node; and means for receiving, from the UE, a measurement report generated based on the report configuration information.

In another aspect the disclosure provides a user equipment, UE, comprising: means for receiving, from an access network node, report configuration information comprising an indication of a number of channel state information, CSI, or signal to interference and noise ratio, SINR, values to be included in a measurement report to be transmitted to the access network node by the UE; wherein each of the CSI or SINR values is associated with a respective one of a set of energy saving configurations for transmission of a reference signal by the access network node; and means for transmitting, to the access network node, a measurement report generated based on the report configuration information.

In another aspect the disclosure provides an access network node comprising: means for transmitting, to a user equipment, UE, in a cell provided by the access network node, energy saving configuration information comprising an indication of one or more energy saving configurations for transmission of a reference signal by the access network node; and means for receiving, from the UE, UE capability information comprising an indication of one or more transition times, wherein each transition time corresponds to a time duration for the UE to transition a state in which the UE is configured for measuring the reference signal transmitted by the access network node based on a respective one of the one or more energy saving configurations.

In another aspect the disclosure provides a user equipment, UE, comprising: means for receiving, from an access network node, energy saving configuration information comprising an indication one or more energy saving configurations for transmission of a reference signal by the access network node; and means for transmitting, to the access network node, UE capability information comprising an indication of one or more transition times, wherein each transition time corresponds to a time duration for the UE to transition a state in which the UE is configured for measuring the reference signal transmitted by the access network node based on a respective one of the one or more energy saving configurations.

In another aspect the disclosure provides an access network node comprising: means for transmitting, to a user equipment, UE, in a cell provided by the access network node, transmission configuration information comprising an indication of one or more energy saving configurations for transmission of a reference signal or a physical downlink shared channel, PDSCH, by the access network node; and means for transmitting the reference signal or the PDSCH; wherein the transmission configuration information comprises at least one of: an indication of a power offset used for transmission of the reference signal or the PDSCH; or an indication of a spatial configuration used for transmission the reference signal or the PDSCH.

In another aspect the disclosure provides a user equipment, UE, comprising: means for receiving, from an access network node, transmission configuration information comprising an indication of one or more energy saving configurations for transmission of a reference signal or a physical downlink shared channel, PDSCH, by the access network node; and means for receiving the reference signal or the PDSCH; wherein the transmission configuration information comprises at least one of: an indication of a power offset used for transmission of the reference signal or the PDSCH by the access network node; or an indication of a spatial configuration used for transmission the reference signal or the PDSCH by the access network node.

In another aspect the disclosure provides an access network node comprising: means for transmitting, to a user equipment, UE, in a cell provided by the access network node, downlink control information, DCI, or downlink grant information comprising an indication of an energy saving configuration for transmission of a physical downlink shared channel, PDSCH, by the access network node; wherein the DCI or downlink grant information comprises an indication of a time after which the UE is to use the indicated energy saving configuration to perform configuration for receiving the PDSCH; and means for transmitting the PDSCH using the energy saving configuration.

In another aspect the disclosure provides a user equipment, UE, comprising: means for receiving, from an access network node, downlink control information, DCI, or downlink grant information comprising an indication of an energy saving configuration for transmission of a physical downlink shared channel, PDSCH, by the access network node; wherein the DCI or downlink grant information comprises an indication of a time after which the UE is to use the indicated energy saving configuration to perform configuration for receiving the PDSCH, or the time after which the UE is to use the indicated energy saving configuration to perform configuration for receiving the PDSCH is preconfigured at the UE; means for performing the configuration for receiving the PDSCH after the indicated time, and means for receiving the PDSCH.

### BRIEF DESCRIPTION OF DRAWINGS

Example embodiments of the disclosure will now be described, by way of example, with reference to the accompanying drawings in which:

FIG. 1 schematically illustrates a mobile (‘cellular’ or ‘wireless’) telecommunication system;

FIG. 2 illustrates a typical frame structure that may be used in the telecommunication system of FIG. 1;

FIG. 3 is a schematic block diagram illustrating the main components of a DU 50 that may be used as part of the RAN equipment 5 for the communication system 1 shown in FIG. 1;

FIG. 4 is a schematic block diagram illustrating the main components of a CU 60 that may be used as part of the RAN equipment 5 for the communication system 1 shown in FIG. 1;

FIG. 5 shows a mobility procedure in which handover occurs from a source (R)AN node to a target (R)AN node;

FIG. 6 shows a random access (RA) procedure that may be performed in the system of FIG. 1;

FIG. 7 shows a simplified illustration of an antenna panel configuration for a base station of the telecommunication system of FIG. 1;

FIG. 8 shows a simplified illustration of an example of how logical antenna ports may be configured for MIMO and and/or beamforming;

FIG. 9 illustrates a number of information elements that may be used for measurement signalling;

FIG. 10 illustrates a different respective use case for CSI-RS measurements for supporting transmission of data (via the PDSCH) and associated DMRS;

FIG. 11 illustrates a different respective use case for CSI-RS measurements for supporting transmission of data (via the PDSCH) and associated DMRS;

FIG. 12 illustrates a different respective use case for CSI-RS measurements for supporting transmission of data (via the PDSCH) and associated DMRS;

FIG. 13 is a simplified illustration of an exemplary mapping between CSI-RS ports, logical antenna elements, and physical antenna elements;

FIG. 14 is a simplified illustration of a number of different CSI-RS to logical antenna array configurations for a single panel antenna;

FIG. 15 is a simplified illustration of a number of different CSI-RS to logical antenna array configurations for a multi-panel antenna;

FIG. 16 illustrates tables that could be used to indicate mapping between sets of antenna ports and corresponding CSI-RS patterns/resources;

FIG. 17 shows an example in which a plurality of CSI are included in a joint CSI report;

FIG. 18 shows an example of a table for indicating a power control offset;

FIG. 19 shows an example of a table for indicating a spatial adaptation pattern;

FIG. 20 shows a first example in which a time offset is used for use of a power control offset parameter;

FIG. 21 shows a second example in which a time offset is used for use of a power control offset parameter;

FIG. 22 is a schematic block diagram illustrating the main components of a UE for the telecommunication system of FIG. 1;

FIG. 23 is a schematic block diagram illustrating the main components of a base station for the telecommunication system of FIG. 1; and

FIG. 24 is a schematic block diagram illustrating the main components of a core network node or function for the telecommunication system of FIG. 1.

### DESCRIPTION OF EMBODIMENTS

### Overview

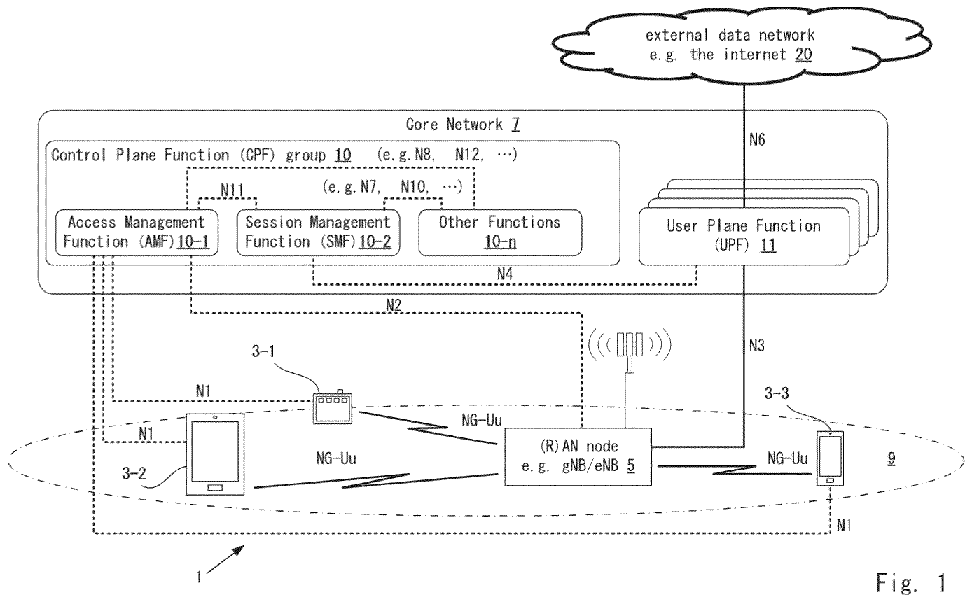

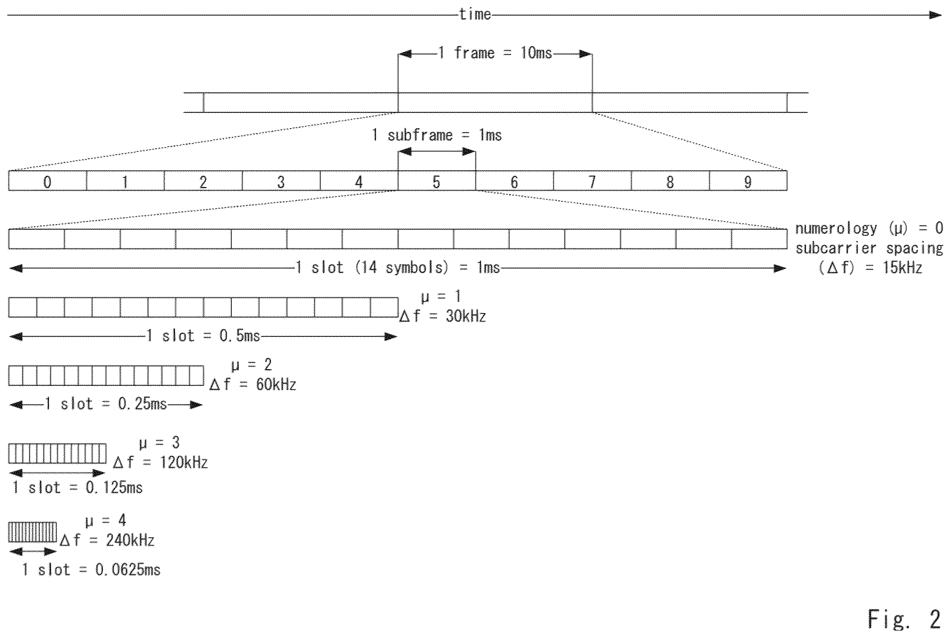

An exemplary telecommunication system will now be described in general terms, by way of example only, with reference to FIGS. 1 and 2.

FIG. 1 schematically illustrates a mobile (‘cellular’ or ‘wireless’) communication system 1 to which example embodiments of the present disclosure are applicable.

In the communication system 1, user equipment (UEs) 3-1, 3-2, 3-3 (e.g. mobile telephones and/or other mobile devices) can communicate with each other via a (radio) access network ((R)AN) node 5 that operates according to one or more compatible radio access technologies (RATs). In the illustrated example, the (R)AN node 5 comprises a base station 5 or ‘gNB’ 5 operating one or more associated cells 9. Communication via the base station 5 is typically routed through a core network 7 (e.g. a 5G core network or evolved packet core network (EPC)).

As those skilled in the art will appreciate, whilst three UEs 3 and one base station 5 are shown in FIG. 1 for illustration purposes, the system, when implemented, will typically include other base stations 5 and UEs 3.

Each base station 5 controls one or more associated cells 9 either directly, or indirectly via one or more other nodes (such as home base stations, relays, remote radio heads, distributed units, and/or the like). It will be appreciated that the base stations 5 may be configured to support 4G, 5G, 6G, and/or any other 3GPP or non-3GPP communication protocols.

The UEs 3 and their serving base station 5 are connected via an appropriate air interface (for example the so-called ‘Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the telecommunication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) 10-2 and a number of other functions 10-n.

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are routed transparently via the base station 5.

One or more UPFs 11 are connected to an external data network (e.g. an IP network such as the internet) via reference point N6 for communication of the user data.

The AMF 10-1 performs mobility management related functions, maintains the NAS signalling connection with each UE 3 and manages UE registration. The AMF 10-1 is also responsible for managing paging. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The base station 5 of the communication system 1 is configured to operate at least one cell 9 on an associated TDD carrier that operates in unpaired spectrum. It will be appreciated that the base station 5 may also operate at least one cell 9 on an associated FDD carrier that operates in paired spectrum.

The base station 5 is also configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on a physical uplink shared channel (PUSCH). The PBCH provides UEs 3 with the Master Information Block, MIB. It also, in conjunction with the PDCCH, supports the synchronisation of time and frequency, which aids cell acquisition, selection and re-selection. The UE 3 may receive a Synchronization Signal Block (SSB), and the UE 3 may assume that reception occasions of a PBCH, primary synchronization signal (PSS) and secondary synchronization signal (SSS) are in consecutive symbols and form a SS/PBCH block. The base station 5 may transmit a number of synchronization signal (SS) blocks corresponding to different DL beams. The total number of SS blocks may be confined, for example, within a 5 ms duration as an SS burst. The periodicity of the SSB transmissions may be indicated to the UE using any suitable signalling (e.g. per serving cell using ssb-periodicityServingCell). The periodicity value for the SSB may be, for example, greater than or equal to 20 ms. For initial cell selection, the UE 3 may be configured to assume that an SS burst occurs with a periodicity of 2 frames. The UE 3 may also be provided with an indication of which SSBs within a 5 ms duration are transmitted (e.g. using ssb-PositionsInBurst).

The DL physical signals may include, for example, reference signals (RSs) and synchronization signals (SSs). A reference signal (sometimes known as a pilot signal) is a signal with a predefined special waveform known to both the UE 3 and the base station 5. The reference signals may include, for example, cell specific reference signals, UE-specific reference signal (UE-RS), downlink demodulation signals (DMRS), and channel state information reference signal (CSI-RS).

Similarly, the UEs 3 are configured for transmission of, and the base station 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, the PUSCH, a physical uplink control channel (PUCCH), and/or a physical random-access channel (PRACH). The UL physical signals may include, for example, demodulation reference signals (DMRS) for a UL control/data signal, and/or sounding reference signals (SRS) used for UL channel measurement.

When the UE 3 initially establishes a radio resource control (RRC) connection with a base station 5 via a cell 9 it registers with an appropriate core network node (e.g, AMF, MME). The UE 3 is in the so-called RRC connected state and an associated UE context is maintained by the network. When the UE 3 is in the so-called RRC idle state, or is in the RRC inactive state, it selects an appropriate cell for camping so that the network is aware of the approximate location of the UE 3 (although not necessarily on a cell level).

The base station 5 may be a base station 5 that is split between one or more distributed units (DUs) 50 and a central unit (CU) 60, with a CU 60 typically performing higher level functions and communication with the next generation core, and with the DU 50 performing lower level functions and communication over an air interface with UEs 3 in the vicinity (i.e. in a cell operated by the base station 5). This type of base station 5 may be referred to as a ‘distributed’ base station 5 or gNB 5. A distributed gNB 5 includes the following functional units:

gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.

gNB Distributed Unit (gNB-DU): a logical node hosting Radio Link Control (RLC), Medium Access Control (MAC) and Physical (PHY) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C (F1 control plane) interface connected with the gNB-DU.

gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the control-plane and user-plane entities may each include an associated transceiver circuit, antenna, network interface, controller, memory, operating system, and communications control module. When the base station 5 comprises a distributed base station, the network interface also includes an E1 interface and an F1 interface (F1-C for the control plane and F1-U for the user plane) to communicate signals between respective functions of the distributed base station.

### Frame Structure

Referring to FIG. 2, which illustrates a typical frame structure that may be used in the communication system 1, the base station 5 and UEs 3 of the communication system 1 communicate with one another using resources that are organised, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 2, the communication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of μ can, in effect, be derived from μ=0 by scaling up in powers of 2 (i.e. SCS=15×2μ kHz). The relationship between the parameter, μ, and SCS (Δf) is as shown in Table 1:

TABLE 1
5G Numerology

| | | Number of slots | |
|---|---|---|---|
| μ | Δf = 2^{μ} · 15[kHz] | per subframe | Slot length (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

### RAN Equipment

### DU

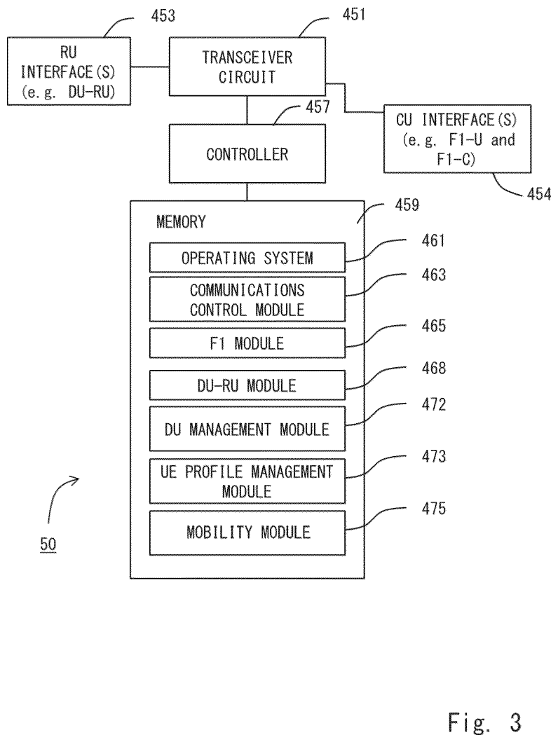

FIG. 3 is a schematic block diagram illustrating the main components of a DU 50 that may be used as part of the RAN equipment 5 for the communication system 1 shown in FIG. 1. As shown, the DU 50 has a transceiver circuit 451 for: transmitting signals to, and for receiving signals from, the communication devices (such as UEs 3) via the radio unit (RU) and the associated DU-RU interface 453; and for transmitting signals to, and for receiving signals from, the CU 60 of the RAN equipment 5 via a CU interface 454 (e.g. comprising an F1 interface which may be split into an F1-U and an F1-C interface for user plane and control plane signalling respectively).

The DU 50 has a controller 457 for controlling the operation of the DU 50. The controller 457 is associated with a memory 459. Software may be pre-installed in the memory 459 and/or may be downloaded via the communications network 1 or from a removable data storage device (RMD) for example. The controller 457 is configured to control the overall operation of the DU 50 by, in this example, program instructions or software instructions stored within memory 459. As shown, these software instructions include, among other things, an operating system 461, a communications control module 463, an F1 module 465, a DU-RU module 468, a DU management module 472, a UE profile management module 473 and a mobility module 475.

The communications control module 463 is operable to control the communication between the DU 50 and one or more RUs (and hence between the DU 50 and the UE 3), and between the DU 50 and the CU 60. The communications control module 463 is configured for the overall control of the reception of signals corresponding to uplink communications from the UE 3 and for handling the transmission of downlink communications to the UE 3.

The F1 module 465 is responsible for the appropriate processing of signals received from, or transmitted to, the CU 60 via one or more CU (e.g. F1) interfaces 454. These signals may be separated into: user plane signals received from, or transmitted to, the CU-UP part of the CU 60 via the F1-U interface; and control plane signals received from, or transmitted to, the CU-CP part of the CU 60 via the F1-C interface.

The DU-RU module 468 is responsible for the appropriate processing of signals received from, or transmitted to, the RU via one or more RU (e.g. DU-RU) interfaces 453.

The DU management module 472 is responsible for managing the overall operation of the DU 50 and the overall performance of the tasks required of the

DU 50. These tasks include, among other things, the generation and transmission of appropriate messages using appropriate signalling application protocols, depending on the functional split between the RU, DU 50 and CU 60, such as interpretation of received MAC signalling and the generation of MAC signalling for transmission. The DU management module 472 may control the overall operation of the DU 50 in accordance with any of the methods describe below, where appropriate.

The UE profile management module 473 is responsible for carrying out functions related to the UE profile including (where applicable): the reception and storage of the UE profile or related assistance/preference information from the UE 3 or from elsewhere in the network; the determination (where applicable) of appropriate mobility specific configurations, based on the UE profile/assistance information/preference information, for implementation at the UE 3 and/or RAN equipment; and/or the provision of configuration information (where applicable) for configuring the UE appropriately with mobility based configurations. The UE profile management module 473 may also store, for example, previous mobility information for a UE 3 (e.g. previous movements of the UE 3 between different communication cells of the network). It will be appreciated that, depending on implementation, the gNB-DU may not implement at least some of these features.

The mobility module 475 is responsible for controlling mobility procedures for one or more UEs 3. For example, the mobility module 475 may be configured to perform one or more measurements for UE 3 mobility, or to select a candidate cell for handover, in accordance with any of the methods described below.

CU

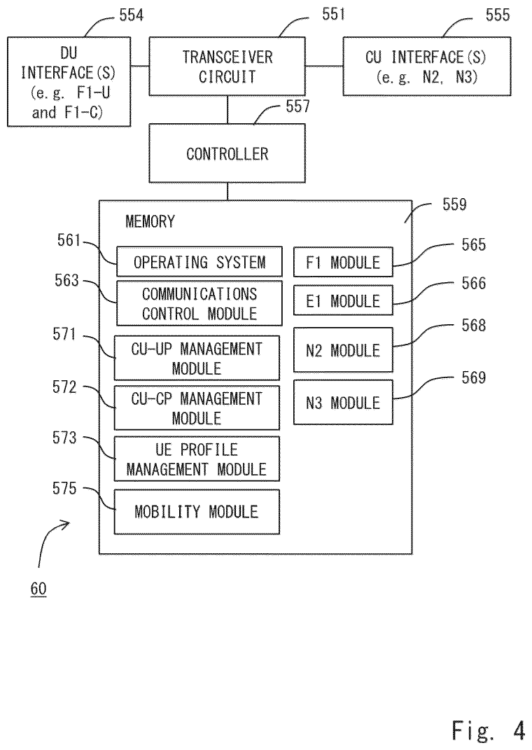

FIG. 4 is a schematic block diagram illustrating the main components of the CU 60 of the RAN equipment for the communication system 1 shown in FIG. 1. As shown, the CU 60 has a transceiver circuit 551 for: transmitting signals to, and for receiving signals from, the DU 50 via one or more DU interfaces 554 (e.g. comprising an F1 interface which may be split into an F1-U and an F1-C interface for user plane and control plane signalling respectively); and for transmitting signals to, and for receiving signals from, the functions of the core network 7 via one or more core network interfaces 555 (e.g. comprising the N2 and N3 interfaces or the like).

The CU 60 has a controller 557 to control the operation of the CU 60. The controller 557 is associated with a memory 559. Software may be pre-installed in the memory 559 and/or may be downloaded via the communications network 1 or from a removable data storage device (RMD) for example. The controller 557 is configured to control the overall operation of the CU 60 by, in this example, program instructions or software instructions stored within memory 559.

As shown, these software instructions include, among other things, an operating system 561, a communications control module 563, an F1 module 565, an E1 module 566, an N2 module 568, an N3 module 569, a CU-UP management module 571, a CU-CP management module 572, a UE profile management module 573, and a mobility module 575. The functions of the mobility module 575 are the same as described above with reference to FIG. 3.

The communications control module 563 is operable to control the communication between the CU 60 and one or more DUs 50 (and hence between the CU 60 and the UE 3), and between the CU 60 and the core network 7. The communications control module 563 is configured for the overall control of the reception of signals corresponding to uplink communications from the UE 3 and for controlling the transmission of downlink communications.

The F1 module 565 is responsible for the appropriate processing of signals received from, or transmitted to, the DU 50 via one or more DU (e.g. F1) interfaces 554. These signals include: user plane signals received at, or transmitted by, the CU-UP part of the CU 60 via the F1-U interface; and control plane signals received at, or transmitted by, the CU-CP part of the CU 60 via the F1-C interface.

The E1 module 566 is responsible for the appropriate processing of signals transmitted between the CU-UP part of the CU 60 and the CU-CP part of the CU 60 via the corresponding internal CU interface (e.g. E1).

The N2 module 568 is responsible for the appropriate processing of signals received from, or transmitted to, the AMF 8-1 via one or more corresponding core network interfaces (e.g. N2) 555.

The N3 module 569 is responsible for the appropriate processing of signals received from, or transmitted to, one or more core network user plane functions via one or more corresponding core network interfaces (e.g. N3) 555.

The CU-UP management module 571 is responsible for managing the overall operation of the CU-UP part of the CU 60 and the overall performance of the tasks required of the CU-UP.

The CU-CP management module 572 is responsible for managing the overall operation of the CU-CP part of the CU 60 and the overall performance of the tasks required of the CU-CP. These tasks include, among other things, the generation and transmission of appropriate messages using appropriate signalling application protocols, depending on the functional split between the RU, DU 50 and CU 60, such as interpretation of received RRC signalling and the generation of RRC signalling for transmission.

The UE profile management module 573 is responsible for carrying out functions related to the UE (mobility) profile including (where applicable): the reception and storage of the UE profile or related assistance/preference information from the UE 3 or from elsewhere in the network; the determination of appropriate mobility specific configurations, based on the UE profile/assistance information/preference information, for implementation at the UE 3 and/or RAN equipment 5; and/or the provision of configuration information for configuring the UE appropriately with mobility based configurations. The UE profile management module 573 may also store previous mobility information for a UE 3 (e.g. previous movements of the UE 3 between different communication cells of the network). It will be appreciated that, depending on implementation, the gNB-CU 60 may not implement at least some of these features.

### System Information and SIB

It will be appreciated that transmissions in a cell 9 of a base station 5 may include one or more broadcast transmissions, one or more unicast transmissions for reception by a UE 3, and/or one or more multicast transmissions for reception by a group of UEs 3. System information (SI) transmitted in a cell may include ‘minimum SI’ (MSI) and ‘other SI’ (OSI). The OSI may be broadcast on-demand, for example using a downlink shared channel (DL-SCH). The OSI may be broadcast upon request from a UE 3 that is in a radio resource control (RRC) idle or RRC inactive state. The OSI may also be requested by a UE 3 that is in the RRC connected state, for example via one or more dedicated RRC transmissions.

The SI may include information for enabling (e.g. configuring) the UE 3 to complete a cell selection, may include information for enabling the UE 3 to complete a cell reselection procedure, or for enabling the UE 3 to receive one or more paging messages transmitted in a cell. SI may be broadcast using a Master Information Block (MIB) and one or more System Information Blocks (SIB).

The MSI comprises the MIB and system information block 1 (SIB1). The MIB includes information for use by the UE 3 to receive SIB1, for example a subcarrier spacing for SIB1. The MIB provides information corresponding to a Control Resource Set (CORESET) and Search Space. SIB1 may be referred to as ‘remaining MSI’ (RMSI). SIB1 may be transmitted in a dedicated RRC message, and other SIB (e.g. SIB2 to SIB9) may be transmitting using one or more other suitable RRC transmissions (e.g. another dedicated RRC message). The MIB and SIB1 may provide the UE 3 with an indication of scheduling information for receiving and decoding the other SIB, such as SIB2 to SIB9, and may provide information for use by the UE 3 to receive one or more paging messages. The OSI may comprise, for example, SIB2 to SIB9 transmitted using a DL-SCH in SI messages. A mapping of SIB2 to SIB9 to corresponding SI messages may be provided to the UE 3 by the base station 5. MIB and SIB1 to SIB9 are described in more detail, for example, in 3GPP TS 38.331. SIB2 provides information for intra-frequency, inter-frequency and inter-system cell reselection. SIB3 provides cell-specific information for intra-frequency cell reselection. SIB4 provides information for inter-frequency cell reselection. SIB5 provides information regarding inter-system cell reselection towards 4G (LTE). SIB6 and SIB7 provide information for an earthquake and tsunami warning system (ETWS). SIB8 provides information for a commercial mobile alert service (CMAS) notification, for example to provide warning text messages to the UE 3. SIB9 includes information regarding coordinated universal time (UTC), global positioning system (GPS) time (e.g. for GPS initialisation) and local time.

SIB may be broadcast periodically (e.g. according to a predetermined periodic pattern), or alternatively may be provided ‘on-demand’, for example in response to a request from a UE 3. For example, MIB may be transmitted with a periodicity of 80 ms and repetitions made within 80 ms, and SIB1 may be transmitted with a periodicity of 160 ms and a variable transmission repetition periodicity within 160 ms (e.g. 20 ms). SIB1 can be used to indicate to a UE 3 which SIB are transmitted periodically and which SIB are available on-demand in response to a request from the UE 3. A UE 3 may be configured to request on-demand SIB using message 1 (MSG1), which may be referred to as a MSG1-based on-demand SI request, or message 3 (MSG3), which may be referred to as a MSG3-based on-demand SI request.

A physical broadcast channel (PBCH) can be used to broadcast the MIB. The base station 5 may transmit the PBCH with synchronisation signals (SS) (e.g. primary synchronisation signal (PSS) and secondary synchronisation signal (SSS)) in a SS/PBCH Block. The SS/PBCH block comprises four orthogonal frequency-division multiplexed (OFDM) symbols that are mapped to PSS, SSS and PBCH associated with a demodulation reference signal (DM-RS). In the frequency domain, an SS/PBCH block comprises 240 contiguous subcarriers. When the UE 3 is in an RRC connected state, the base station 5 may provide the UE 3 with an indication of resources used for the SS/PBCH, for example using dedicated signalling. SIB1 may be transmitted using a physical downlink shared channel (PDSCH). The OSI may be similarly transmitted, for example, using a PDSCH. When one or more beamformed transmissions are transmitted in a cell provided by the base station 5, some of the SI (e.g. some of the SIB) may only be transmitted using particular beams, or using a particular transmission/reception point (TRP).

### UE Mobility

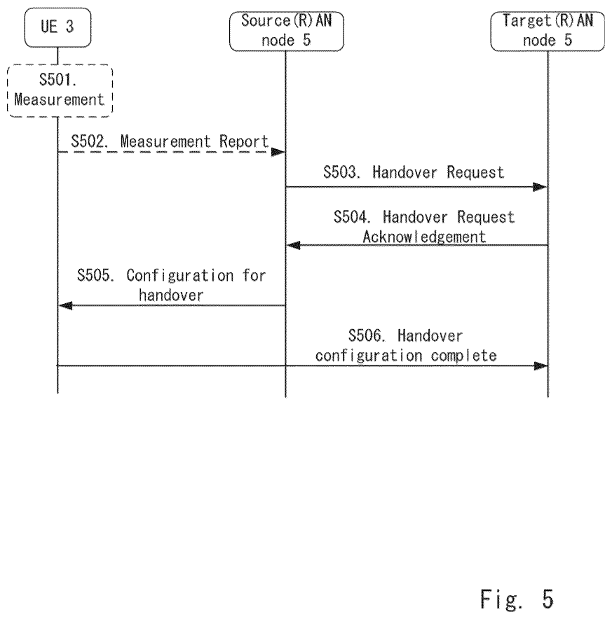

FIG. 5 shows an overview of a mobility procedure that may be performed in a communication system 1 of the type illustrated in FIG. 1. In this example, a handover of a UE 3 from a source base station 5 to a target base station 5 is performed.

In optional step S501 the UE 3 performs a measurement. The measurement may be a measurement of a signal transmitted by the source (R)AN node 5 or a measurement of a signal transmitted by the target (R)AN node 5. The measurement may be a measurement of a signal strength, that can be used as part of a determination that the UE 3 is to be handed over from the source (R)AN node 5 to the target (R)AN node. In optional step S502 the UE 3 transmits a measurement report to the source (R)AN node 5 that provides an indication of the result of the measurement. The measurement report may be transmitted from the UE 3 to the source base station 5 in an RRC message. In this example the source (R)AN node uses the information provided in the measurement report to determine that the UE 3 is to be handed over to the target (R)AN node 5. However, it will be appreciated that a determination that handover to the target (R)AN node is to be performed may alternatively (or additionally) be based on a measurement performed at the source (R)AN node 5 or at the target (R)AN node 5. Alternatively, a determination that handover of the UE 3 is to be performed may be based on a factor other than a signal measurement, such as a level of congestion in a cell operated by the source (R)AN node 5.

In Step S503 the source (R)AN node 5 transmits a handover request to the target (R)AN node 5, requesting handover of the UE 3 from the source (R)AN node 5 to the target (R)AN node 5. The handover request may include an indication of, for example, an identity of the source (R)AN node 5, a cause value for the handover, an identity of the target cell, UE 3 context information (e.g. a maximum bit rate of the UE 3, or security capabilities of the UE 3), and UE 20 history information. If the handover has been triggered by the measurement report received by the source (R)AN node 5 in step S502, then the cause value may indicate, for example, that the handover is desirable for radio reasons. Alternatively, if the handover has been triggered to reduce the load at the source (R)AN node 5, the cause value may indicate that the handover is for reducing load in the serving cell. The handover request message may also include an indication of the AMF 10-1 that is serving the UE 3.

In step S504, the target (R)AN node transmits an acknowledgement of the handover request (which may be referred to as a “handover request acknowledgement” message). The handover request acknowledgement message includes an indication of handover configuration information for the handover that is to be forwarded to the UE 3. The handover request acknowledgement message may also include configuration information that enables the source (R)AN node 5 to begin forwarding user plane data for the UE 3 to the target (R)AN node 5.

The transmissions of steps S503 and S504 may be performed over an Xn interface between the source (R)AN node 5 and the target (R)AN node 5 (and therefore the handover procedure in this example may be referred to as an Xn-based handover procedure). Steps S501 to S504 may be referred to as a ‘handover preparation phase’.

In step S505, the source (R)AN node 5 transmits the handover configuration information to the UE 3. The configuration information for the handover may be, for example, an RRC configuration transmitted in an RRC configuration message or an RRC reconfiguration message. In step S506, the UE 3 applies the received configuration for handover and transmits an indication to the target (R)AN node 5 that configuration for the handover is complete. The message transmitted in step S505 may be, for example, an RRC Reconfiguration Complete message. Steps S505 and S506 may be referred to as a ‘handover execution phase’.

Following the handover execution phase, the UE 3 is operable to transmit uplink transmissions to the target (R)AN node 5 (e.g uplink data) and receive downlink transmissions from the target (R)AN node 5 (e.g. downlink data).

It will be appreciated that mobility methods and handover procedures for the UE 3 are not restricted to the example illustrated in FIG. 5. For example, the UE 3 may be configured to perform a conditional handover (CHO) in which the UE 3 determines whether handover of the UE 3 to a candidate cell is to be performed based on one or more execution conditions. It will also be appreciated that handover may be performed in which the DU 50 changes but the CU 60 remains the same (inter-DU intra-CU handover), in which both the DU 50 and CU 60 change (inter-DU inter-CU handover), or between two cells operated by the same DU 50.

### Random Access

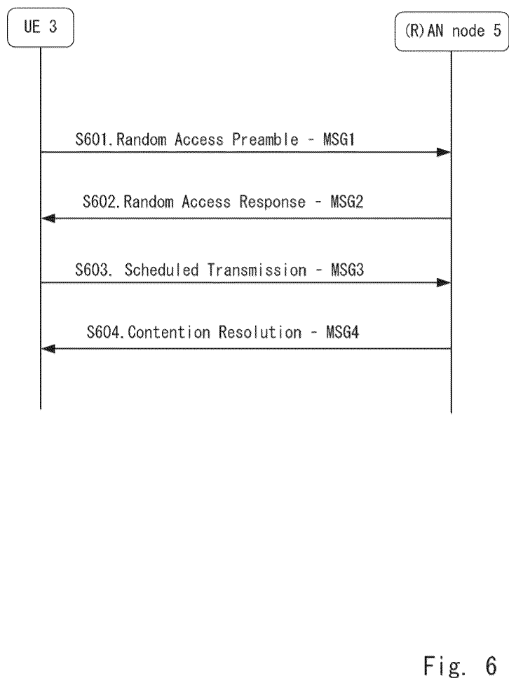

FIG. 6 shows a random access (RA) procedure that may be performed in the system of FIG. 1. The RA procedure can be used, for example, for initial access by a UE 3 that is in the RRC idle mode, or for a transition from the RRC inactive mode to the RRC connected mode. The RA procedure may also be used during handover of the UE 3 from a source base station to a target base station (e.g. the handover procedure described above with reference to FIG. 5), for initial access to the target base station 5.

In step S601 the UE 3 transmits a random access preamble to the base station 5. In this example the UE 3 selects the random access preamble to transmit from a group of random access preambles that are shared with other UEs 3. The transmission of step S601 may be referred to as message 1 (MSG1), and is transmitted using PRACH.

In step S602 the base station 5 transmits a random access response to the UE 3. The transmission of step S602 may be referred to as message 2 (MSG2). The random access response indicates time and/or frequency resources (e.g. resource blocks and/or symbols) for use by the UE 3 to transmit a subsequent transmission to the base station 5. The random access response may also include further information for use by the UE 3 for communication with the base station 5, such as a timing advance (TA) value.

In step S603 the UE 3 transmits a transmission to the base station 5 using the indicated time and/or frequency resources. The transmission of step S603 may be referred to as message 3 (MSG3). The transmission of step S603 may be a layer 2 (L2) or layer 3 (L3) message. The transmission of step S603 may comprise, for example, an RRC setup request, an RRC resume request, an RRC reestablishment request, or an RRC reconfiguration complete message.

If two UEs 3 selected and transmitted the same random access preamble in step S601, and receive and decode MSG2 transmitted by the base station 5 in step S602, then the two UEs may transmit MSG3 using the same time and/or frequency resources. This situation can be referred to as ‘contention’ or ‘collision’. In order to resolve the contention, in step S604 the base station 5 transmits a content resolution message to the UE 3. The transmission of step S604 may be referred to as message 4 (MSG4). MSG4 indicates to the UE 3 whether the MSG3 transmitted by the UE 3 in step S603 was received and successfully decoded by the base station. MSG3 transmitted in step S603 may not have been received or successfully decoded by the base station 5 if the base station 5 decoded a MSG3 transmitted by another UE 3 that is in contention with the UE 3, or if interference occurred between the MSG3 transmitted by the two UEs 3. If MSG3 transmitted by the UE 3 was not decoded by the base station 5 (which the UE 3 may determine if the UE 3 does not receive MSG4 from the base station 5), then the UE 3 returns to step S601 of the method and transmits another MSG1 to the base station 5 (e.g. after selecting a different random access preamble).

The procedure illustrated in FIG. 6 is an example of a contention based RA procedure in which the UE 3 selects the random access preamble from a group of preambles that could also be used by other UEs 3 (and therefore contention can occur if two of the UEs 3 select the same random access preamble). Alternatively, the base station 5 may transmit a random access preamble assignment to the UE 3 before the UE 3 transmits MSG 1 to the base station 5, in which case the RA procedure is contention free (and the contention resolution in step S604 need not be performed). The random access preamble assignment may be transmitted to the

UE 3 using an RRC message or layer 1 (L1) signalling (e.g. using DCI carried by a PDCCH). In the method illustrated in FIG. 5, a random access preamble assignment for communication with the target base station 5 may be transmitted to the UE 3 in step S505.

MSG1 and/or MSG 3 may be used by the UE 3 to request on-demand SI from the base station 5.

### Antenna Elements

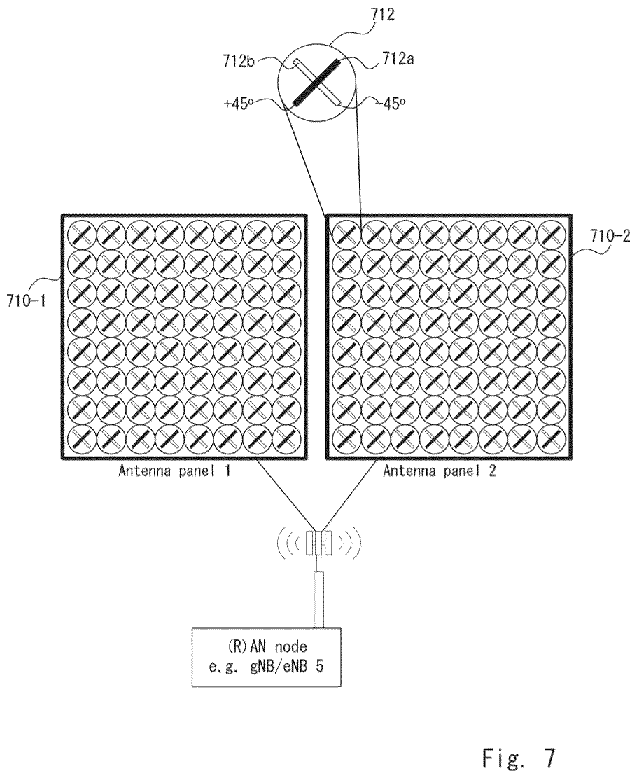

Referring now to FIG. 7, which is a simplified illustration of an antenna panel configuration for a base station 5, the base station 5 of the communication system 1 includes an antenna that has a plurality of antenna panels 710-1, 710-2 (two in this example, although more are possible). Each antenna panel 710 comprises a plurality of physical antenna elements 712a, 712b arranged in cross-polar pairs of antenna elements 712. In the illustrated example each cross-polar pair 712 comprises a plus 45° antenna element 712a and a minus 45° antenna element 712b, although it will be appreciated that other arrangements are possible. In FIG. 7, each antenna panel 710 is shown, for illustrative purposes, to comprise an 8×8 array of 64 cross-polar pairs of antenna elements 712 (128 physical antenna elements 712a, 712b).

It will be appreciated that whilst the base station 5 is described as having a plurality of antenna panels, the base station 5 (or another similar base station 5 of the communication system 1) may have a single panel, because at least some operators currently support a single antenna panel per base station site. It will also be appreciated that the number of antenna elements is not restricted to 128 physical antenna elements (64 cross-polar pairs). One or more antenna panels may, for example include 64 physical antenna elements (in 32 cross-polar pairs), 32 physical antenna elements (in 16 cross-polar pairs), etc. . . . .

The UE 3 also has an antenna that may have multiple antenna elements.

The use of antennas with multiple physical antenna elements allows the base station 5 and UE 3 to perform transmissions (and receptions) using logical antenna ports that are mapped to a subset of one or more of the physical antenna elements 712. Transmissions sharing the same antenna port will therefore experience the same propagation channel.

The use of logical antenna ports at the base station 5 or UE 3 allows multiple input multiple output (MIMO) communication in which plural streams of data (referred to as ‘transmission layers’) may be transmitted (or received), in parallel, using the same time and frequency resources but via different logical antenna ports. Moreover, the ability to map a given logical antenna port to a subset including a plurality of physical antenna elements allows the base station 5 or UE 3 to beamform transmissions made via that logical antenna port (i.e., by applying an appropriate amplitude and/or phase adjustments at each physical antenna element).

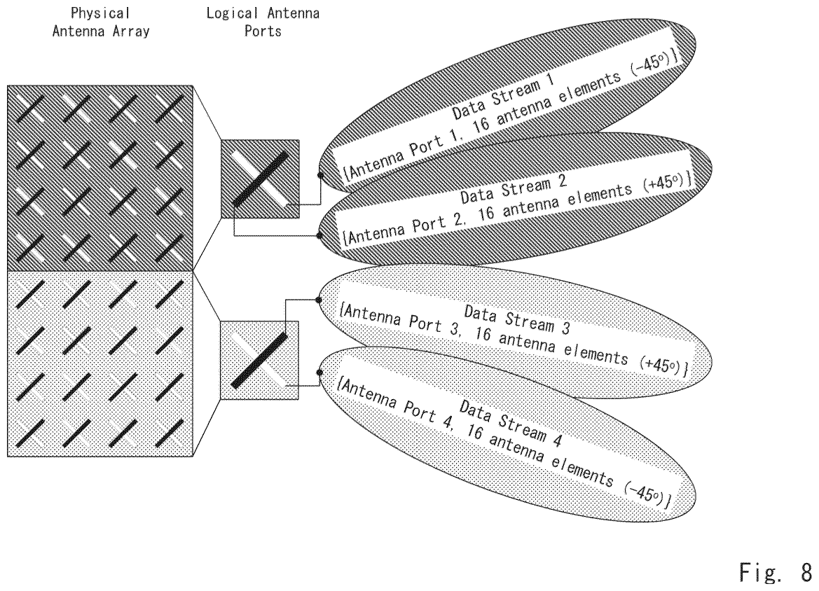

FIG. 8 illustrates a simplified example of how logical antenna ports may be configured for MIMO and and/or beamforming. As seen in FIG. 8, the simplified example involves a single panel array of 64 physical antenna elements (32 cross-polar pairs (+45°/−45°)). There are, in the example, four distinct MIMO transmission layers (e.g., for 4×4 MIMO) each of which is transmitted via a different respective set of 16 physical antenna elements that is mapped to a corresponding antenna port. As each antenna port is mapped to multiple physical antenna elements beamforming is possible and hence the respective data streams transmitted for each transmission layer can be beamformed to form a corresponding beam as illustrated.

With no precoding an original signal, SN, transmitted in a particular data stream/transmission layer from transmitter antenna port, N, and received at receiver antenna port, M, will be affected by the propagation channel, hMN, between those antenna ports. A signal, YM, received at receiver antenna port, M, will thus correspond to the sum of each original signal as modified by the respective propagation channel. This may be represented mathematically using matrix algebra. For example, for the simplified case of two transmitter antenna ports and two receiver antenna ports (e.g., 2×2 MIMO), the received signals may be represented as follows:

$${Y}_{1} = {h}_{11} {S}_{1} + {h}_{12} {S}_{2} \qquad [ Equation 1 a ]$$

$${Y}_{2} = {h}_{21} {S}_{1} + {h}_{22} {S}_{2} \qquad [ Equation 1 b ]$$

Where Y is the received signal vector

$$( e . g . , [ \begin{matrix}{Y}_{1} \\ {Y}_{2}\end{matrix} ] ) ,$$

S is the original signal vector

$$( e . g . , [ \begin{matrix}{S}_{1} \\ {S}_{2}\end{matrix} ] ) ,$$

and H is the propagation channel coefficient matrix

$$( e . g . , [ \begin{matrix}{h}_{11} & {h}_{12} \\ {h}_{21} & {h}_{22}\end{matrix} ] ) ,$$

this may be generally represented using matrix representation as Y=HS, or more specifically for the 2×2 MIMO example:

$$[ \begin{matrix}{Y}_{1} \\ {Y}_{2}\end{matrix} ] = [ \begin{matrix}{h}_{11} & {h}_{12} \\ {h}_{21} & {h}_{22}\end{matrix} ] [ \begin{matrix}{S}_{1} \\ {S}_{2}\end{matrix} ] \qquad [ Equation 2 ]$$

As long as there is sufficient orthogonality between the respective propagation paths experienced by signals in each transmission layer, the original signals can be recovered at the receiver based on propagation coefficients derived from measurements of reference signals (e.g. DMRS) transmitted via the same propagation paths (i.e., transmitted and received by the same respective antenna ports). For example, Equation 2 may be solved by deriving an inverse channel coefficient matrix (e.g., based on reference signal measurements) and multiplying the received signals by this matrix.

Nevertheless, the propagation paths may not be completely orthogonal and, in order to improve orthogonality of the received signals precoding can be applied to the original signals before they are transmitted. Specifically, where P is the matrix of precoding parameters

$$( e . g . , [ \begin{matrix}{P}_{11} & {P}_{12} \\ {P}_{21} & {P}_{22}\end{matrix} ] )$$

this may be generally represented using matrix representation as Y=HPS, or more specifically for the 2×2 MIMO example:

$$[ \begin{matrix}{Y}_{1} \\ {Y}_{2}\end{matrix} ] = [ \begin{matrix}{h}_{11} & {h}_{12} \\ {h}_{21} & {h}_{22}\end{matrix} ] [ \begin{matrix}{P}_{11} & {P}_{12} \\ {P}_{21} & {P}_{22}\end{matrix} ] [ \begin{matrix}{S}_{1} \\ {S}_{2}\end{matrix} ] \qquad [ Equation 3 ]$$

### CSI-RS

The base station 5 is operable to transmit reference signals (RS) in one or more cells 9 that it operates. These reference signals include channel state information RS (CSI-RS). The CSI-RS may be used by the UE 3 for a number of different purposes including, for example, CSI reporting in which the UE 3 derives channel state information (CSI) including one or more channel quality indicators (CQIs), rank indicators (RIs), and/or precoding matrix indicators (PMIs) from CSI-RS measurements and reports them to the base station 5 in a CSI report. The CQI is an index (typically 4 bits) value representing a signal to interference and noise ratio (SINR). The CQI value also corresponds to a modulation and coding scheme (MCS) to be used for each layer. The RI indicates a number of MIMO transmission layers requested by the UE 3 (albeit the base station 5 might not necessarily use the requested number of MIMO transmission layers). The PMI is used by the UE 3 to report parameters defining a preferred precoding matrix to be applied for downlink transmissions (albeit the base station 5 may not use the requested precoding). A layer indicator (LI) may also be included in the CSI report for identifying the strongest layer from the set of layers indicated by the RI.

The CSI-RS may also be used by the UE 3 for beam management, including the refinement of initial beam selection based on SSBs. For example, the base station 5 may use a set of relatively broad beams for transmission of the SSBs and a set of narrower (more directional) beams for the CSI-RS. The UE 3 can be configured, by the base station 5, to measure each CSI-RS transmission to identify the best CSI-RS beam and to report this to the base station 5 (e.g., by means of a CSI report including a CSI-RS indicator (CRI) identifying the strongest CSI-RS and hence CSI-RS beam). The UE 3 may also be configured to report the (Layer 1) RSRP which has been measured for the strongest CSI-RS.

The CSI reporting configuration for CSI can be periodic (P-CSI) using PUCCH, aperiodic (A-CSI) using PUSCH, or semi-persistent (SP-CSI) using PUCCH and DCI-activated PUSCH. In periodic CSI reporting, the reporting time periods (i.e. the time periods defining the reporting points) are determined at a higher layer, using RRC signalling and, at the appropriate junctures, CSI data is transmitted, by the UE 3 to the scheduler (base station 5), using PUCCH; whereas, in aperiodic reporting, CSI feedback is triggered as required by the base station 5, using DCI over the PDCCH. In this case, the CSI data is transmitted by the UE 3 over the PUSCH. A-CSI may form the principal CSI feedback framework of a communication system, or it may be a supplementary configuration, and triggered, for example, to deal with a failed detection of P-CSI or SP-CSI reporting.

CSI-RS may either be either zero power (ZP-CSI-RS) or non-zero power (NZP-CSI-RS). ZP-CSI-RS are empty resource elements, used primarily for interference measurement. NZP-CSI-RS are used for most of the procedures including channel measurement, beam management, beam measurement, connected mode mobility etc. A non-zero-power CSI-RS may be configured, for example, using a NZP-CSI-RS-Resource information element (IE), or using a CSI-RS-Resource-Mobility field in an CSI-RS-ResourceConfigMobility IE. NZP CSI-RS can be used for interference measurement (IM), for example as part of determining a Signal to Interference plus Noise Ratio (SINR). For cases in which interference is likely to be primarily due to inter-cell interference, CSI IM resources may be used. These resources may be used to measure background interference originating from neighbouring cells. The UE 3 may be provided a configuration for receiving (and measuring) the CSI-RS from the base station 5 (e.g. using a CSI Report Configuration, CSI-ReportConfig, transmitted from the base station 5 to the UE 3). As will be described in more detail later, the CSI Report Configuration includes an indication of resources for channel measurement, NZP-CSI-RS resources for interference management, and CSI-IM resources.

There are also several other ways in which the CSI-RS may be used including, for example, for connected mode mobility, radio link failure detection, beam failure detection/recovery, and fine timing of time and/or frequency synchronisation.

### CSI Reporting

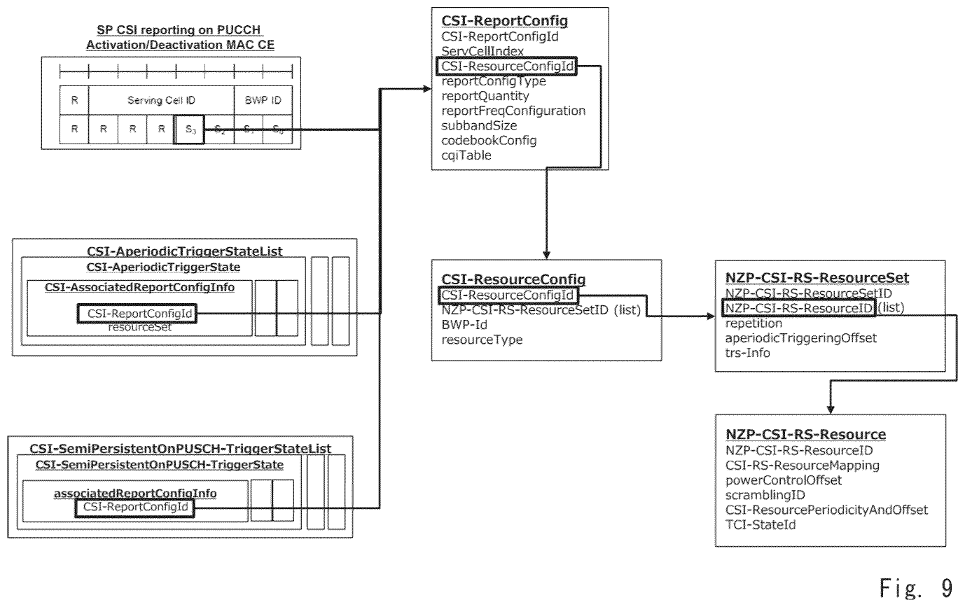

The base station 5 can configure how the UE 3 measures CSI-RS and transmits corresponding reports to the base station 5 using appropriate measurement configuration signalling. FIG. 9 illustrates a number of information elements that may be used for such measurement configuration signalling in the system 1. It will be appreciated that these are shown for illustrative purposes and are purely exemplary.

The base station 5 can, for example, use the measurement configuration signalling (e.g., using a CSI-measconfig IE) to configure the UE 3 to measure and report specific resources used for CSI-RS (e.g., using the CSI-ReportConfig IE in FIG. 9). Multiple different reporting configurations can be configured and identified by an appropriate identifier (e.g., the CSI-ReportConfigID IE in FIG. 9).

The base station 5 can, for example, configure the UE 3 to provide different types of CSI reports (e.g., using the CSI-ReportConfig IE in FIG. 9) providing different information, depending on the requirements for the use case, by setting a reporting quantity parameter (e.g., the reportQuantity IE in FIG. 9) appropriately. For example, the UE 3 may be configured: to report only RI, and CQI for one or more associated CRIs, by setting the reporting quantity parameter appropriately (e.g., to cri-RI-CQI); to report RI, PMI and CQI for one or more associated CRIs by setting the reporting quantity parameter appropriately (e.g., to cri-RI-PMI-CQI), or to report RI, LI, PMI and CQI for one or more associated CRIs by setting the reporting quantity parameter appropriately (e.g., to cri-RI-LI-PMI-CQI). Similarly, for beam management procedures, the UE 3 may be configured to report RSRP or SINR for one or more associated CRIs, by setting the reporting quantity parameter appropriately (e.g., to cri-RSRP or cri-SINR), to report RSRP or SINR for one or more associated SSBs, by setting the reporting quantity parameter appropriately (e.g., to ssb-Index-RSRP or ssb-Index-SINR).

The base station 5 can also configure the UE 3 to provide CSI reports based on different report timing configurations (e.g., using the CSI-ReportConfig IE in FIG. 9). For example, the UE 3 may be configured for persistent reporting, semi-persistent reporting on the PUSCH, semi-persistent reporting on the PUCCH, or aperiodic reporting. Aperiodic reporting and semi-persistent reporting on PUSCH may be triggered using a PUSCH DCI. For example, DCI (e.g., using DCI format 0_1) may trigger aperiodic reporting by providing a CSI request that points to a respective index of each of one or more corresponding aperiodic trigger states (e.g., configured in the CSI-AeriodicTriggerStateList IE shown in FIG. 9). Each of these trigger states is associated with one or more corresponding CSI report configurations (e.g., identified by one or more associated CSI-ReportConfig IEs in FIG. 9). Semi-persistent reporting on PUSCH may be triggered in a similar way (e.g., by identifying one or more CSI-ReportConfig IEs of one or more CSI-SemiPersistentOnPUSCH-TriggerStates listed in the CSI-SemiPersistentOnPUSCH-TriggerStateList shown in FIG. 9).

Semi-persistent reporting on PUCCH may be triggered using a MAC CE (as illustrated in FIG. 9).

Each CSI report configuration identifies at least one CSI resource configuration (e.g., using the CSI-ResourceConfigId IE in FIG. 9) for measurement (e.g., channel measurement). The identified CSI resource configuration is defined by a corresponding IE (e.g., using the CSI-ResourceConfigId IE in FIG. 9) that includes a list of identifiers corresponding to one or more sets of CSI resources (e.g. a list of one or more NZP-CSI-RS-ResourceSetIDs for non-zero power CSI-RS as shown in FIG. 9) and associated configuration information. The associated configuration information may, for example, identifying an associated bandwidth part (e.g., by means of the bandwidth part ID, BWP ID, in FIG. 9) and a resource type (e.g., by means of the resource Type IE in FIG. 9). The identified resource type may, for example, identify the CSI-RS resource to be a periodic, a semi-persistent, or an aperiodic type. Each resource set comprises one or more specific CSI resource configurations represented by associated identifiers (e.g. one or more NZP-CSI-RS-ResourceIDs for non-zero power CSI-RS as shown in FIG. 9) that each point to the specific configuration information (e.g. defined by an NZP-CSI-RS-Resource IE for non-zero power CSI-RS as shown in FIG. 9) for that CSI resource configuration).

Accordingly, the base station 5 can configure multiple CSI report configuration instances and CSI resource configuration instances. It will be appreciated that multiple resource sets can be configured per CSI resource config for the case of aperiodic CSI RS resources.

In this way reporting of specific CSI resource sets for specific use cases may be configured. For example, a CSI-RS resource set may be configured that includes CSI-RS resources for different beams for beam management purposes. A CSI-RS resource set may be configured that includes a single CSI-RS resource for a number, N, of ports for channel estimation purposes.

Different resource sets may also be configured per resource configuration in for the case of multiple transmission reception points (TRPs). In this scenario, different resource sets can be part of same CSI resource configuration for aperiodic CSI reporting or can be part of different CSI resource configuration for periodic/semi-persistent CSI reporting. It will, nevertheless, be appreciated that in the case of the same number of ports for all TRPs it is possible to configure CSI-RS resources belonging to different TRPs within same resource set.

In another example, a CSI report for multiple secondary cells (SCells) can be triggered together by including CSI reporting configurations for different SCells within the information defining a single CSI aperiodic trigger state.

The base station 5 can also configure the UE 3 to provide either a wideband or a subband granularity of reporting (e.g., using a reportFreqConfiguration IE in a CSI-ReportConfig IE). For example CQI and/or partial PMI can be reported per subband setting a corresponding indicator (e.g., a cqi-FormatIndicator IE and/or a pmi-FormatIndicator IE respectively) appropriately (e.g., to widebandCQI or subbandCQI and/or to widebandPMI or subbandPMI respectively).

The base station 5 can also configure the UE 3 with a time restriction for channel measurements (and/or interference measurements). When the time restriction is configured, the UE 3 is configured to derive the measurements for computing CSI values based only on the last measured CSI-RS occasion associated with the CSI report.

It will be appreciated that the UE 3 may need to transmit quite a few CSI reports (based on the CSI configuration) but there may be limited space available in PUCCH or uplink control information (UCI) part of the PUSCH. Moreover, the CSI report payload size can increase significantly in presence of subband based reporting. Hence, prioritization rules are defined for indicating which CSI report parameters should be transmitted with the highest priority

For CSI reporting of RI, CQI and PMI, a CSI report for a single CSI resource may be divided into two parts: a first part containing RI, CRI, CQI for a first codeword; and a second part containing PMI and CQI for a second codeword. The first part can be transmitted in whole while it is possible to omit a portion of the second part (depending on allowed size of UCI). For UCI coding, the first part of each CSI report is encoded into the UCI, and the second part of the CSI report is encoded based on amount of space available.

### Relationship Between CSI-RS for Channel Estimation and DMRS

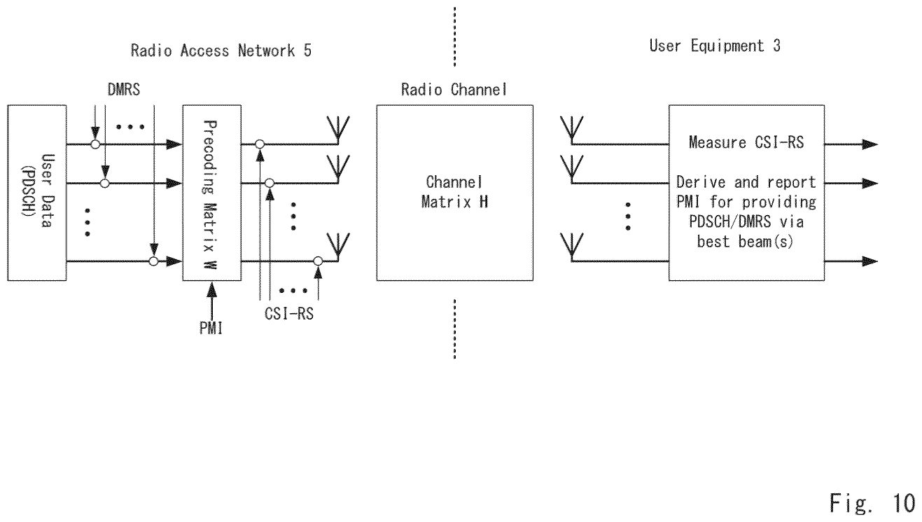

FIGS. 10 to 12 each illustrate a different respective use case for CSI-RS measurements for supporting transmission of data (via the PDSCH) and associated DMRS.

As illustrated in FIG. 10, when CSI-RS transmissions are used for PMI reporting purposes it is not always necessary to apply any CSI-RS beamforming and the CSI-RS can be transmitted directly from the physical antenna elements. In this case there is effectively a one-to-one mapping between each CSI-RS port and an associated antenna element. The lack of any CSI-RS beamforming means that the CSI-RS transmissions will radiate across the cell area with a wide beamwidth.

The UE 3 measures the CSI-RS and identifies, from a PMI codebook, a set of precoding parameters (and hence an associated PMI) which, if applied to the CSI-RS ports, would generate one or more best (narrow) pre-coded beams towards the UE 3 using CSI-RS ports. The UE 3 reports this PMI to the base station 5 (e.g., in a CSI report including other relevant parameters such as CQI and/or RI) and the base station 5 can, if it decides to use the reported PMI, apply the precoding parameters appropriately to precode/beamform the DMRS and/or associated PDSCH based on the PMI indication.

On receipt of the PDSCH/DMRS, measurement of the DMRS can be performed in the usual way for estimation of the composite propagation channel (i.e., the propagation channel as modified by precoding/beamforming—e.g., multiplication by the precoding matrix W) and decoding of the PDSCH.

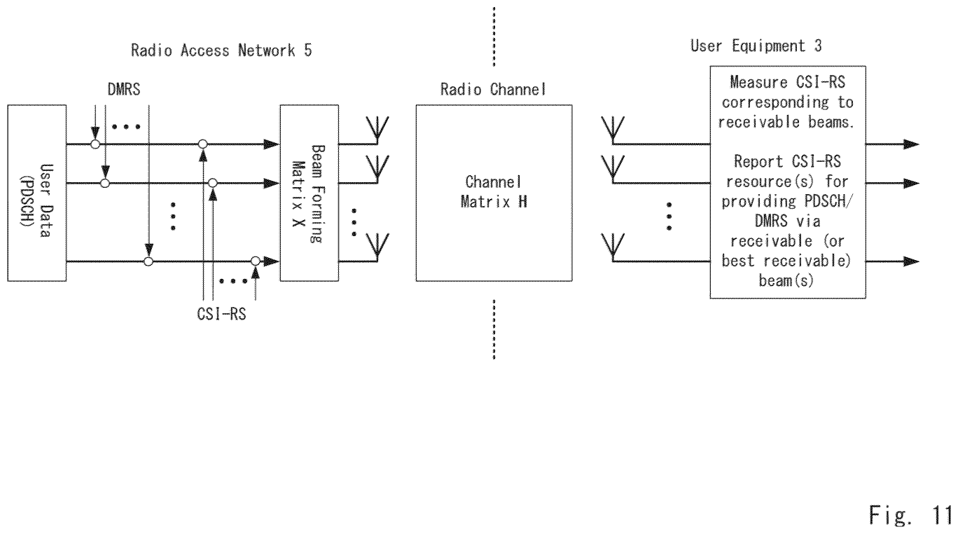

As illustrated in FIG. 11, the CSI-RS transmissions may be beamformed and each CSI-RS resource mapped to a different respective beam (and to an associated set of physical antenna elements). Since the CSI-RS is already beamformed the UE 3 measures the CSI-RS, identifies one or more directional beams on which it can successfully receive data, and reports one or more CSI-RS resources associated with one or more identified beams (or with the best identified beams) to the base station 5. Thus, the base station 5 can schedule resources for the PDSCH (and associated DMRS) using one or more identified beams and the PDSCH (and associated DMRS) can be precoded/beamformed using the same weights as were used for the CSI-RS beamforming of the identified beams.

On receipt of the PDSCH/DMRS, measurement of the DMRS can be performed in the usual way for estimation of the composite propagation channel (i.e., the propagation channel as modified by precoding/beamforming—e.g., multiplication by the beamforming precoding matrix X) and decoding of the PDSCH.

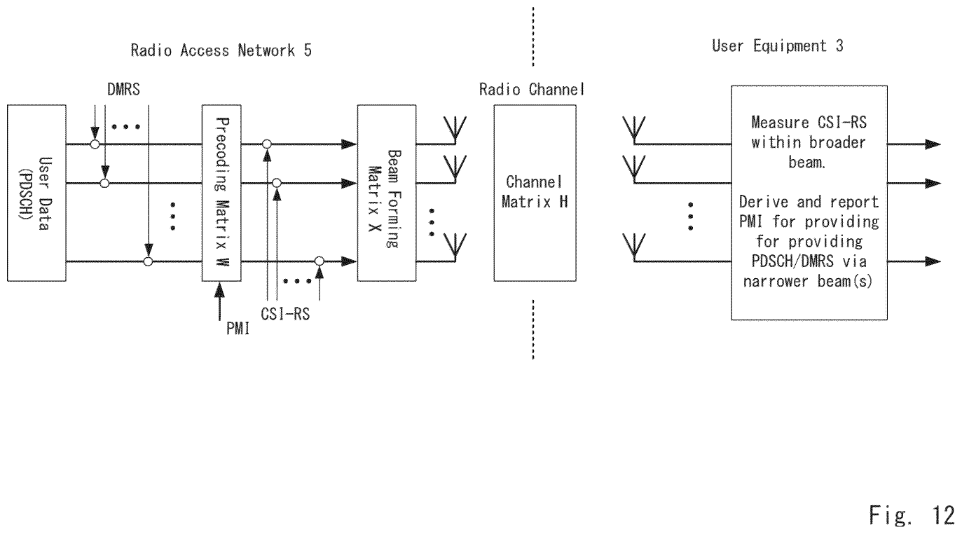

As illustrated in FIG. 12, the CSI-RS transmissions may be beamformed and all the CSI-RS antenna ports mapped to the same beam at a given timing (albeit different beams can be used at different times). Each CSI-antenna port may be mapped to a respective set of physical antenna elements. In this case, even though the CSI-RS is already beamformed, a PMI may be used to indicate a narrower pre-coded beam that can be formed using the CSI-RS antenna ports. Thus, the UE 3 measures the CSI-RS and identifies, from a PMI codebook, a set of precoding parameters (and hence an associated PMI) which, if applied to the CSI-RS transmissions in the current beam, would generate a narrower pre-coded beam towards the UE 3. The UE 3 reports this PMI to the base station 5 (e.g., in a CSI report including other relevant parameters such as CQI and/or RI) and the base station 5 can, if it decides to use the reported PMI, apply the precoding parameters appropriately to precode/beamform the DMRS and/or associated PDSCH based on the PMI indication. This example has particular relevance to frequency range 2 (FR2) and hence TDD that uses FR2.

On receipt of the PDSCH/DMRS, measurement of the DMRS can be performed in the usual way for estimation of the composite propagation channel (i.e., the propagation channel as modified by precoding/beamforming—e.g., multiplication by the precoding matrix W and beamforming precoding matrix X) and decoding of the PDSCH.

Mapping from CSI-RS to CSI-RS Antenna Ports/Antenna Elements

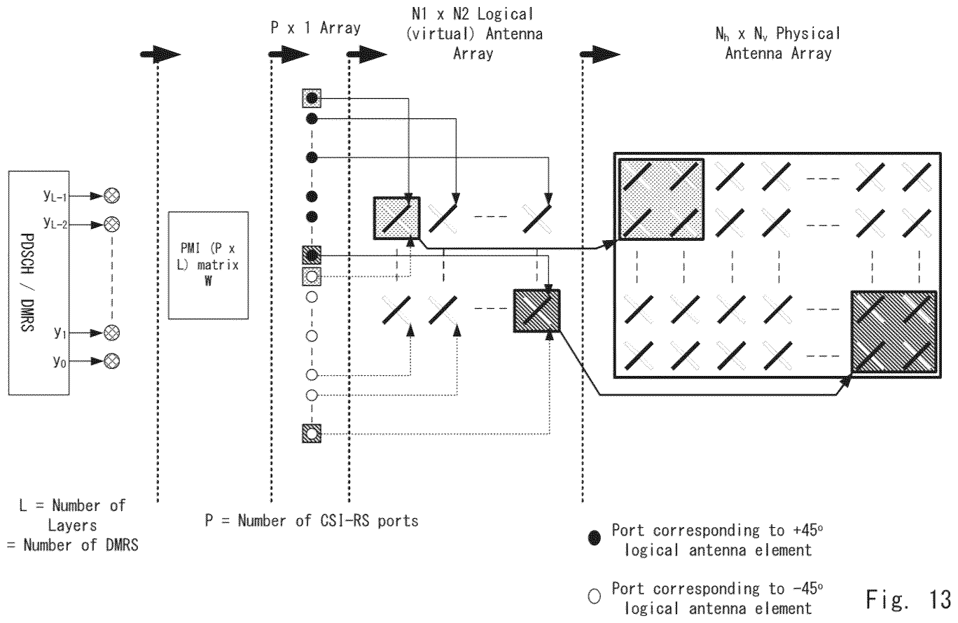

Referring to FIGS. 13 to 15, the communication system 1 provides a mapping between each CSI-RS antenna port and a corresponding logical antenna element of a logical antenna array. There are a number of different configurations that may be used for the logical antenna arrays. The mapping from the logical antenna elements to physical antenna elements depends on the specific implementation employed at the base station 5/UE 3 and is transparent to the operation of the base station 5/UE 3. This use of logical CSI-RS antenna ports in this way allows a reduction in the total number of CSI-RS ports which are used for transmission to improve radio resource usage (because each CSI-RS port has a respective radio resource overhead) and energy efficiency.

FIG. 13 illustrates an exemplary mapping between CSI-RS ports, logical antenna elements of a virtual antenna array, and physical antenna elements of a physical antenna array (single panel in this example). It will be appreciated that the illustration is simplified for clarity and not every mapping is shown.

As shown in FIG. 13 the logical antenna array has N1 logical cross-polar pairs in the horizontal direction and N2 logical cross-polar pairs in the vertical direction. Each logical cross-polar pair includes a +45° logical antenna element and a −45° logical antenna element. There is a CSI-RS antenna port corresponding to each logical antenna element and hence the total number, P, of CSI-RS antenna ports is equal to the total number of cross-polar pairs (N1×N2) multiplied by the number of antenna elements per cross-polar pair (2)—i.e., P=2×N1×N2.

Each logical cross-polar pair (and hence its associated logical antenna elements) is mapped to a respective group of physical cross-polar pairs (and hence and associated group of physical antenna elements). In the example there are four physical antenna elements/cross-polar pairs mapped to each logical antenna element/cross-polar pair (although it will be appreciated that any suitable mapping may be used).

Data and DMRS transmitted via an appropriate number, L, of transmission layers (where L may be greater than or equal to one) is precoded via an appropriate precoding matrix for transmission via each of the CSI-RS ports. As each CSI-RS port is mapped to multiple antenna elements it is possible to perform beamforming in respect of signals transmitted via the CSI-RS antenna ports. For example, a base station 5 (e.g., that operates in FR 2) may decide to use beamforming for each CSI-RS resource transmission (to increase coverage). In this case, the base station may configure multiple CSI-RS resources (one for each beam) where each CSI-RS resource has a plurality (N) of CSI-RS ports. This is similar to the scenario illustrated in FIG. 12.

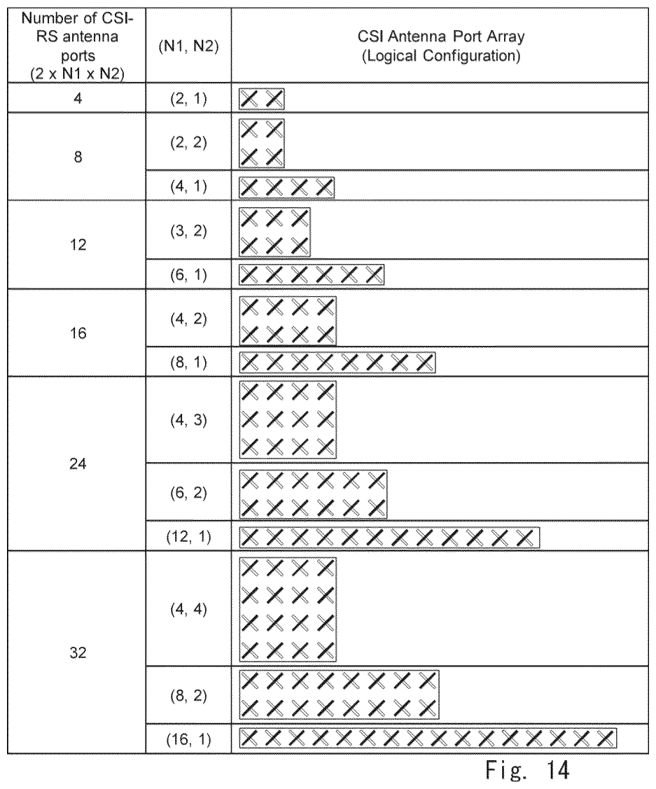

It will be appreciated that while the illustration shows an array in which there is a two-dimensional array of at least six logical cross-polar pairs (twelve logical antenna elements) the array may be one dimensional (e.g., N2=1) and there may be fewer logical cross-polar pairs/antenna elements. For example, if there is no specific requirement to have multiple beams in a vertical direction (e.g., in rural area), then the base station may choose to map each CSI-RS antenna port to a logical antenna element corresponding to all the physical antenna elements in a column of a physical antenna array. In this case N2 would equal 1 and beamforming may only occur in the horizontal direction. FIG. 14 illustrates, for example, a number of different CSI-RS to logical antenna array configurations for a single panel antenna.

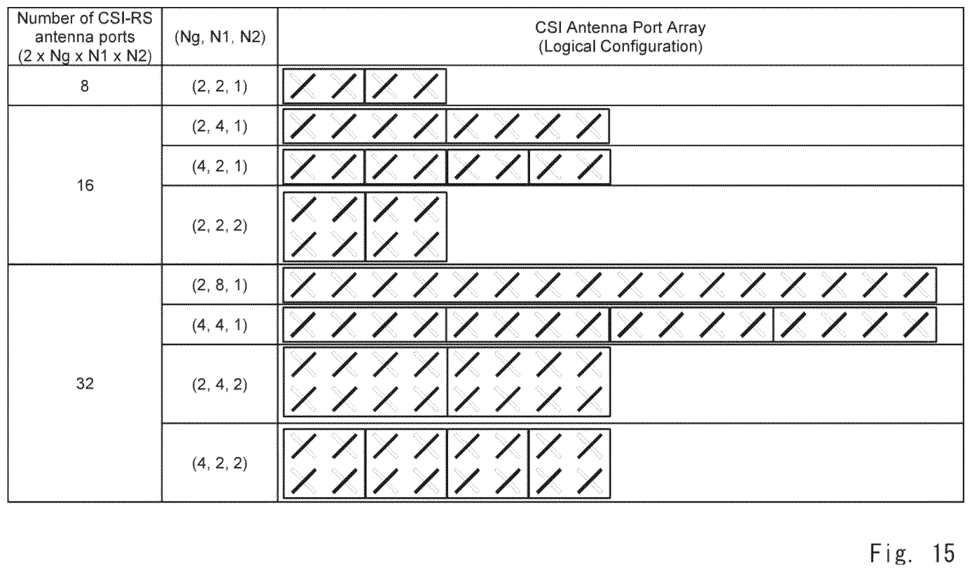

It will also be appreciated that for antennas having multiple antenna panels additional CSI-RS ports are configurable. FIG. 15 illustrates, for example, a number of different CSI-RS to logical antenna array configurations for multi-panel antennas (where Ng is the number of antenna panels). For multiple antenna panels, each the antenna elements of each panel are mapped to a respective N1×N2 array of logical cross-polar pairs of antenna elements. Accordingly, for multi-port antennas, the total number of CSI-RS ports is given by 2×Ng×N1×N2 (where Ng, N1 and N2 are configurable by the network).

It will be appreciated that, in the examples of FIG. 14 and FIG. 15 higher values of N1 imply more beams can be created in horizontal direction whereas higher values of N2 imply more beams can be created in vertical direction.

### Precoder Matrix Indication (PMI)

As described above, the PMI may be used by the UE 3 to report a preferred precoding for PDSCH transmissions. The PMI (or at least partial PMI) may be sent as feedback to the base station 5 in either closed loop or semi-open loop transmission schemes. The PMI can indicate precoding for only MIMO (typically for smaller antenna configurations) or for both MIMO and beamforming (typically for larger antenna configurations). The base station 5 does not have to apply the precoding indicated by the PMI and does not need to inform the UE 3 of the actual precoding applied. Nevertheless, the UE 3 can determine the combined effect of the actual precoding and the propagation channel based on measurements of the DMRS, which are precoded in the same way as the PDSCH, and thus decode the PDSCH.

A number of precoder matrix types that may be predefined based on a set of corresponding logical antenna configurations (e.g., logical antenna configurations as illustrated in FIGS. 14 and 15). These may, for example, be precoder matrices specified by a relevant standard (e.g., 3GPP TS 38.214)).

The precoder matrices are categorised into four different codebook categories: type 1, single panel; type 1, multi-panel; type 2, single panel; type 2, port selection. Type 1 codebooks generally provide relative course information, whereas Type 2 codebooks provide more detailed information albeit at the expense of signalling overhead.

For codebook type 1, the precoder matrices may, by way of illustration, have a structure similar to one of the two following general formats (with the occasional exception):

$${W}_{parameters}^{( no of layers )} = [ \begin{matrix}{v}_{1} & {v}_{2} & … & {v}_{n} \\ {φ}_{1} {v}_{1} & {φ}_{2} {v}_{2} & … & {φ}_{n} {v}_{n}\end{matrix} ] \qquad [ Equation 4 ]$$

$${W}_{parameters}^{( no of layers )} = [ \begin{matrix}{v}_{1} & {v}_{2} & … & {v}_{n} \\ {θ}_{1} {v}_{1} & {θ}_{2} {v}_{2} & … & {θ}_{n} {φ}_{n} {v}_{n} \\ {φ}_{1} {v}_{1} & {φ}_{2} {v}_{2} & … & {φ}_{n} {v}_{n} \\ {φ}_{1} {θ}_{1} {v}_{1} & {φ}_{2} {θ}_{2} {v}_{2} & … & {φ}_{n} {θ}_{n} {v}_{n}\end{matrix} ] \qquad [ Equation 5 ]$$

In each case the number of rows corresponds to the number of CSI-RS ports (P) and the number of columns to the number of transmission layers (L).

v₁, v₂, . . . vₙ effectively define the pre-coded beam weights to be applied to CSI-RS ports. The specific codebook that is configured effectively determines how many unique possible values for vₙ can be present per precoding matrix (1 or 2 or 3).

θₙ indicates a weight corresponding to each of the two possible polarizations and, in most cases, the different values of θₙ in a precoding matrix will differ only in respect of their sign (+/−).

φₙ is an additional weight term added to account for a non-uniform multi-antenna panel scenario (so that pre-coded beams from the different panels are added constructively e.g., when a gap between adjacent panels results in an inter-panel spacing between antenna elements being different to the intra-panel spacing).

For codebook type 1, for 1 or 2 transmission layers, two different codebook modes may be used. Using codebook mode 1 allows for higher granularity in horizontal and vertical directions for wideband, whereas codebook mode 2 has higher resolution for subbands.

Each precoding matrix W can be understood to corresponds to the product of two matrices (W=W₁W₂). The first matrix W₁ includes a set of beam weights (i.e., (vₙ)) and can be understood to represent the long-term channel characteristics (wideband), while W₂ is a vector that captures the short-term channel characteristics (subband). W₁ can be understood to contain multiple beam directions, whereas the W₂ matrix can be understood to select a subset of beam directions (for codebook mode 2) and/or to perform phase shifting (for codebook modes 1 and 2).

It will be appreciated that for a given scenario different transmission layers may be accomplished by using different beams and/or polarizations. For example, a signal received via different beams, or via different polarizations, may be configured to have uncorrelated (orthogonal) propagation channels.

The PMI reporting may be divided into two stages. The first stage provides feedback (referred to as i1) to the base station 5 representing wideband information that does not change rapidly with time whereas the second stage provides feedback (referred to as i2) to the base station 5 representing subband information which changes rapidly. The i1 part of PMI effectively indicates one or more beam weight values (vₙ) in the precoding matrix. The i1 part of the PMI is reported for a wide band (i.e., a single measurement for all CSI-RS subbands) whereas the i2 part of the PMI can be reported per subband (based on the CSI report configuration as described previously).

In some cases (e.g., semi-open loop transmission schemes) the UE 3 may be configured to report only i1. For example, the base station 5 can configure the UE 3 to provide a CSI report (e.g., using a CSI-ReportConfig IE) that provides partial precoding information (e.g., i1 but not i2) by setting the reporting quantity parameter appropriately. The UE 3 may, for example, be configured to report RI, i1 and CQI for one or more associated CRIs, by setting the reporting quantity parameter appropriately (e.g., to cri-RI-i1-CQI) or to report RI, i1 without CQI for one or more associated CRIs, by setting the reporting quantity parameter appropriately (e.g., to cri-RI-i1).

By way of illustration, the exemplary case of 2-layer PMI feedback for a single panel type 1 codebook, using codebook mode 1, will now be considered. In this case the precoding matrix is specified as:

$${W}_{l , {l}^{′} , m , {m}^{′} , n}^{( 2 )} = \frac{1}{\sqrt{2 {P}_{CSI - RS}}} [ \begin{matrix}{v}_{l , m} & {v}_{{l}^{′} , {m}^{′}} \\ {φ}_{n} {v}_{l , m} & - {φ}_{n} {v}_{{l}^{′} , {m}^{′}}\end{matrix} ] \qquad [ Equation 6 ]$$

where P_{CSI-RS} is the number of CSI-RS antenna ports and φₙ=e^{jπn/2}.

The UE reports i1 and i2 where i1=[i_{1,1}, i_{1,2}, i_{1,3}]. i_{1,1} effectively indicates the index of the beam to be used in the horizontal direction, i_{1,2} effectively indicates the index of the beam to be used in the vertical direction, i_{1,3} effectively indicates a second beam (with respect to an offset to the first beam) that should be formed for PDSCH transmission (multiple beams can provide independent orthogonal channels), and i2 indicates the weight used for a second polarization.

The translation from the beam indices to actual beam weights in the case of 5G is defined in the relevant standards (e.g., 3GPP TS 38.214).

i1 and i2 are mapped to W based on the following prespecified table:

codebookMode = 1

| i_{1,1} | i_{1,2} | i₂ | |
|---|---|---|---|
| 0, 1, ... , N₁O₁ − 1 | 0, 1, ... , N₂O₂ − 1 | 0, 1 | ${W}_{{i}_{1 , 1} , {i}_{1 , 1} + {k}_{1} , {i}_{1 , 2} , {i}_{1 , 2} + {k}_{2} , {i}_{2}}^{( 2 )}$ |

k₁ and k₂ are determined based on i_{1,3} based on following prespecified table:

| | N₁ > N₂ > 1 | | N₁ = N₂ | | N₁ = 2, N₂ = 1 | | N₁ > 2, N₂ = 1 | |
|---|---|---|---|---|---|---|---|---|
| i_{1, 3} | k₁ | k₂ | k₁ | k₂ | k₁ | k₂ | k₁ | k₂ |
| 0 | 0 | 0 | 0 | 0 | 0 | 0 | 0 | 0 |
| 1 | O₁ | 0 | O₁ | 0 | O₁ | 0 | O₁ | 0 |
| 2 | 0 | O₂ | 0 | O₂ | | | 2O₁ | 0 |
| 3 | 2O₁ | 0 | O₁ | O₂ | | | 3O₁ | 0 |

The precoder matrix defined by Equation 6 thus becomes:

$$\frac{1}{\sqrt{2 {P}_{CSI - RS}}} [ \begin{matrix}{v}_{{i}_{1 , 1} , {i}_{1 , 2}} & {v}_{{i}_{1 , 1} + {k}_{1} , {i}_{1 , 2} + {k}_{2}} \\ {e}^{j π {i}_{2} / 2} {v}_{{i}_{1 , 1} , {i}_{1 , 2}} & - {e}^{j π {i}_{2} / 2} {v}_{{i}_{1 , 1} + {k}_{1} , {i}_{1 , 2} + {k}_{2}}\end{matrix} ]$$

The first column of the matrix effectively corresponds to a first transmission layer for transmissions via a first beam from a first CSI-RS port and is defined by i_{1,1} and i_{1,2}. The second column of the matrix effectively corresponds to a second transmission layer for transmissions via a second beam from a second CSI-RS port and is defined by i_{1,1}+k₁ and i_{1,2}+k₂.

For each rank (number of transmission layers), the UE 3 can attempt to determine the parameters for i1 and i2, based on CSI-RS reception, which result in the best performance and hence indicate the values to the base station.

The base station 5 can configure restrictions on the values reported. For example, the base station 5 can indicate using a bitmap (e.g., in codebook configuration IE) which values of i_{1,1} and i_{1,2} are restricted. Similarly, the base station 5 can indicate using a bitmap (e.g., in codebook configuration IE) which rank values are restricted.

### Network Energy Saving (NES)

NES techniques may be performed, for example, in the spatial domain or the power domain. NES in the spatial domain may comprise controlling the number of physical antenna elements, or TX/RX RUs, used to transmit the CSI-RS (or another type of transmission). NES in the power domain may comprise reducing the transmission power for particular transmissions (e.g. the CSI-RS or PDSCH).

### Spatial Domain

Spatial domain methods for NES include flexible switching on/off of the spatial antenna elements of the base station 5. The switch on/off of the spatial elements may result in modification of the mapping between the CSI ports and the physical antenna ports. The base station 5 may be configured to shut down some of spatial elements (and/or reduce the transmission power of some of the spatial elements) in order to achieve energy saving. Due to the change in configuration for transmissions, it is advantageous for CSI to be promptly reported by the UE 3 to the base station 5, for use in scheduling and resource allocation by the base station 5. Without receiving CSI corresponding to transmissions using the reduced number of spatial elements and/or reduced transmission power, communication performance in the system 1 may be degraded. Particularly advantageous methods for mitigating against this issue will be described later.

As described above, the UE may be configured with multiple CSI-RS resources. The CSI-RS resources, resource sets or resource settings/configurations may be associated with only one spatial adaptation pattern. Alternatively, the CSI-RS resources, resource sets or resource settings/configurations may be associated with one or more spatial adaptation patterns. Similarly, independent or separate CSI report configurations may be used, where each CSI report configuration corresponds to a respective spatial adaptation pattern. Alternatively, one CSI report configuration may comprise a plurality of CSI report sub-configurations, in which each sub-configuration corresponds to a respective one spatial adaptation pattern.

By transmitting CSI reports corresponding to a respective different number of used spatial elements, the base station 5 is able to perform control to adjust the number of spatial elements for the PDSCH. CSI-RS and CSI reporting configurations are BWP-specific, and a BWP adaptation framework can be utilized for the adaptation for a UE 3 capable of multiple BWPs and dynamic BWP switching. The UE 3 may be configured to determine which CSI are to be reported to the base station 5, and multiple CSI may be reported in a single CSI report.

One CSI-RS resource may be configured with multiple antenna port configurations and/or power offsets. L1/L2 signaling may be used to indicate the activated antenna port configurations and/or power offsets. Alternatively, multiple

CSI-RS resource groups may be associated with different antenna port configurations and/or power offsets, and these resource groups may belong to the same CSI-RS Resource set. L1/L2 signaling can be used to indicate the activated group of resources.

For L1-SINR computation (determination), the UE 3 may be configured with NZP CSI-RS resource and/or SS/PBCH block resources. For interference measurement, the UE 3 may be configured with NZP CSI-RS or CSI-IM resources. For L1-SINR reporting, a higher layer parameter ‘nrofReportedRS’ in the CSI-ReportConfig (illustrated in FIG. 9) may be configured to be one, in which case the reported L1-SINR value is defined by a 7-bit value. If the higher layer parameter ‘nrofReportedRS’ is configured to be greater than one, or if the higher layer parameter ‘groupBasedBeamReporting’ is configured as ‘enabled’, then the UE 3 uses differential L1-SINR based reporting, in which the largest measured value of L1-SINR is quantized to a 7-bit value, and the differential L1-SINR is quantized to a 4-bit value. In other words, the differential L1-SINR can be reported with reference to the largest measured L1-SINR value (e.g. that is part of the same L1-SINR reporting instance). When a NZP CSI-RS is configured for channel measurement and/or interference measurement, the reported L1-SINR valued are not compensated by one or more power offsets (e.g. indicated by the higher layer power control offset parameter ‘powerControlOffsetSS’ or ‘powerControlOffset’).

The UE 3 can be configured with multiple CSI report configurations (CSI-ReportConfig). The number of ports associated with the different CSI report configurations can be set to different values. Then UE can report CSI corresponding to different numbers of ports in corresponding CSI reports. The CSI reports may comprise an indication of RI, LI, CQI, or PMI, for example. The UE 3 may be configured to report multiple CSI in one CSI report, where each of the multiple CSI may correspond to different number of ports (thereby enabling the base station to perform more efficient configuration and scheduling for the downlink transmissions).

If a higher layer parameter ‘cqi-BitsPerSubband’ in the CSI-ReportConfig is not configured, then for each sub-band index s, a 2-bit sub-band differential CQI can be defined as:

$$Sub - band Offset level ( s ) = sub - band CQI index ( s ) - wideband CQI index \qquad [ Equation 7 ]$$

A mapping from the 2-bit sub-band differential CQI values to the offset level is illustrated in Table 2 below:

TABLE 2
Mapping sub-band differential CQI values to offset level

| Sub-band differential CQI value | Offset Level |
|---|---|
| 0 | 0 |
| 1 | 1 |
| 2 | ≥2 |
| 3 | ≤−1 |

Alternatively, if the higher layer parameter ‘cqi-BitsPerSubband’ in the CSI-ReportConfig is configured, for each sub-band index s, a 4-bit sub-band CQI can be reported.

The use of a different number of ports, frequency resources or transmission powers in NES methods can result in unreliable CSI-RS measurement results being generated by the UE 3 and reported to the base station. To mitigate against this problem, methods for indicating to the UE 3 how the CSI-RS is being transmitted by the base station 5 can be used.

For example, if the number of antennas for CSI-RS is changed by the base station 5, the CSI reported before the change in the number of antennas may not be suitable for use in data scheduling after the change. The change in the number of spatial elements (or transmission power) may result in a CSI-RS resource (set) configured for measurement by the UE 3 becoming out of date. If an inaccurate CSI report is used to schedule the data, then potentially the data may not be received at the UE 3, and retransmission may be needed.

Improved methods related to spatial element adaptation may help the UEs to adapt the already configured CSI-RS configuration such as dynamic/semi-persistent ON-OFF of CSI-RS or to reconfigure the CSI-RS configuration, with respect to adapted number of spatial elements/ports. Improved methods for CSI-RS measurement and reporting, with respect to NES in the spatial domain, will be described later.

### Power Domain

NES methods in the power domain may be applicable, for example, to one or more of transmission of PDSCH, CSI-RS, DMRS, and broadcast channels/signals. For example, NES methods may comprise modifying power offset values between the PDSCH and CSI-RS.

An SSB reference power, ss-PBCH-BlockPower is defined in SIB1. A power control offset, powerControlOffsetSS, is defined between the (NZP) CSI-RS and the SSB. This power control offset may be semi-statically configured via RRC signaling. The power offset configurations for PDSCH and CSI-RS may be BWP-specific.

The base station 5 may be configured to adapt the transmission power or power spectral density (PSD) of downlink signals and channels dynamically. This dynamic power adjustment can be used to adapt to different channel conditions, to achieve energy saving. The power offset between transmission of the PDSCH and CSI-RS (configured by powerControlOffset) may be semi-statically configured. Adaptation of power offset values between PDSCH and CSI-RS by the base station 5 may enable the transmission power of the PDSCH transmissions to be reduced, beneficially resulting in energy savings. However, in order for the base station 5 to efficiently configure the PDSCH transmissions (to reduce the transmission power whilst ensuring reliable reception by the UE 3) it is advantageous for the base station 5 to receive, from the UE 3, CSI corresponding to different power offset values between PDSCH and CSI-RS.

The UE transmits CSI feedback related to the configured DL power offset. However, when transmission power adjustment for the PDSCH is used, a mismatch between the configured power offset and the actual power offset between the PDSCH and CSI-RS may occur. Particularly advantageous methods comprising updating the power offset values between the PDSCH and CSI-RS will be described in more detail later.

### CSI-RS Sub-Configuration

Particularly advantageous methods in which a number of spatial adaptation patterns are used will now be described.

In this example, a configurable number of spatial adaptation patterns (each corresponding to a respective number of antenna ports for a particular CSI-RS pattern) are used. The configurable number of spatial adaptation patterns may be, for example, 2, 4, 8 or 16 patterns, depending on the configuration of the antenna ports at the base station 5.

For example, 32 antenna ports at the base station 5 may correspond to K CSI-RS patterns (without NES in the spatial domain). When a set of 16 of the antenna ports is used, a first (N1) CSI-RS pattern (NES-1) can be used. When a first set of 8 of the antenna ports are used, a second (N2) CSI-RS pattern (NES-2) can be used. When a second set of 8 of the antenna ports (different from the first set) are used, a third (N3) CSI-RS pattern can be used. When a set of 4 of the antenna ports is used, a fourth (N4) CSI-RS pattern can be used. It will be appreciated, therefore, that in this example different CSI-RS patterns are defined for each respective set of antenna ports (in this example, groups of 16, 8 and 4 antenna ports).

Advantageously, information indicating the mapping between each set of antenna ports used for transmission of the CSI-RS and the corresponding CSI-RS pattern is indicated to the UE 3, for example using a table. Beneficially, therefore, the UE 3 is able to determine the CSI-RS pattern/resources associated with each set of antenna ports, and is able to transmit a corresponding CSI report to the base station 5 (enabling the base station 5 to then perform more efficient scheduling and configuration of downlink transmissions).

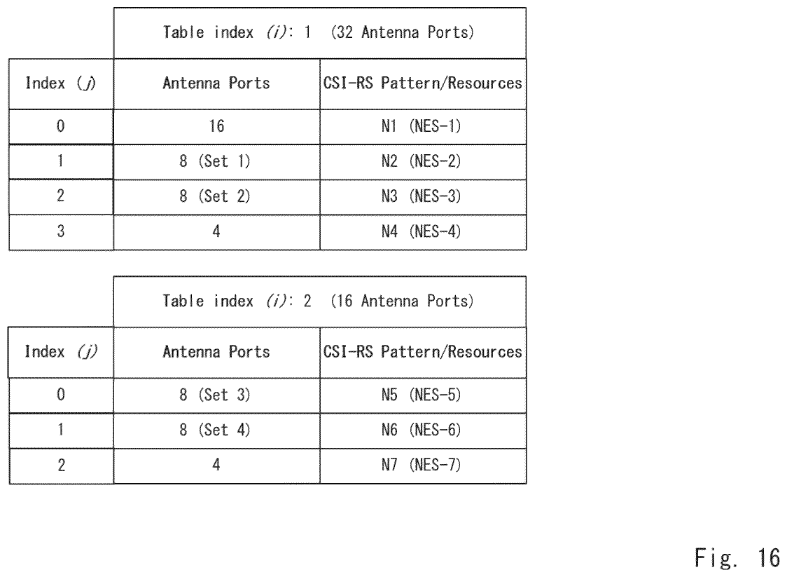

FIG. 16 illustrates tables that could be used to indicate the mapping between the sets of antenna ports used for transmission of the CSI-RS and the corresponding CSI-RS pattern/measurement resources. FIG. 16 shows a first table for a base station having 32 antenna ports available for CSI-RS transmission, and a second table for a base station having 16 antenna ports available for CSI-RS transmission. A table can be identified to the UE 3 by transmitting the corresponding index to the UE 3 (in the present example, a value of 1 indicating that the 32 antenna port table is to be used, and a value of 2 indicating that the 16 antenna port table is to be used). An additional index (j) is used to indicate the set of antenna ports used for transmission of the CSI-RS (and therefore the corresponding CSI-RS pattern/resources). The CSI-RS pattern information illustrated in the tables of FIG. 16, for sub-configuration for spatial adaptation patterns, corresponds to respective CSI-RS measurement resources. Each spatial adaptation pattern is associated with a combination of NZP CSI-RS measurement resources and interference measurement CSI-IM/NZP CSI-RS resources.

Whilst in the examples shown in FIG. 16 the antenna ports and CSI-RS pattern/resources are indicated using the same table as a joint indication, this need not necessarily be the case. Alternatively, for example the antenna ports could be indicated using a first table, and the CSI-RS pattern/resources could be indicated using a second table (addressed either using the same index used to address the first table, or a different index).

The tables may be provided to the UE 3 in any suitable manner. For example, the tables could be transmitted to the UE 3 by the base station 5, or could be pre-configured at the UE 3.

It will be appreciated that the table index i need not necessarily be used. Alternatively, for example, the total number of antenna ports may be explicitly indicated to the UE 3, or could be inferred based on any other suitable information transmitted to the UE 3 from the network. It will also be appreciated that the column indicating the set of antenna ports used for the transmission of the CSI-RS need not necessarily be present. Alternatively, only the index j and an indication of the corresponding CSI-RS pattern/resources may be included in the table. In this case, the UE 3 could include the index j corresponding to the measured CSI-RS when transmitting a corresponding CSI report to the base station 5.

The information for identifying the table and the CSI-RS pattern/resources (in the example of FIG. 16, the indices i and j) could be transmitted to the UE 3 from the base station 5 in any suitable transmission. For example, the information for identifying the table and the CSI-RS pattern/resources could be transmitted to the UE 3 within a configuration for NES (NES configuration information), or within

CSI Report Configuration information (e.g. using the CSI-ReportConfig IE illustrated in FIG. 9). Alternatively, the information for identifying the table and the CSI-RS pattern/resources could be broadcast in a cell of the base station 5, for example using system information (e.g. SIB1).

As described above, CSI feedback may be triggered as required by the base station 5, using DCI over the PDCCH. For example, DCI format 1_0 or 1_1, used for scheduling PDSCH in a cell, may be used to configured the CSI feedback. Advantageously, in the present example in which dynamic adaptation of the spatial adaptation pattern can be used, the DCI can beneficially include an indication of the row of the table (e.g. using the indices i and j) that indicates the spatial adaptation pattern and the corresponding CSI resource set configuration selected by the base station 5.

### CSI Reporting

Particularly advantageous methods for transmitting a CSI report from the UE 3 to the base station 5 will now be described.

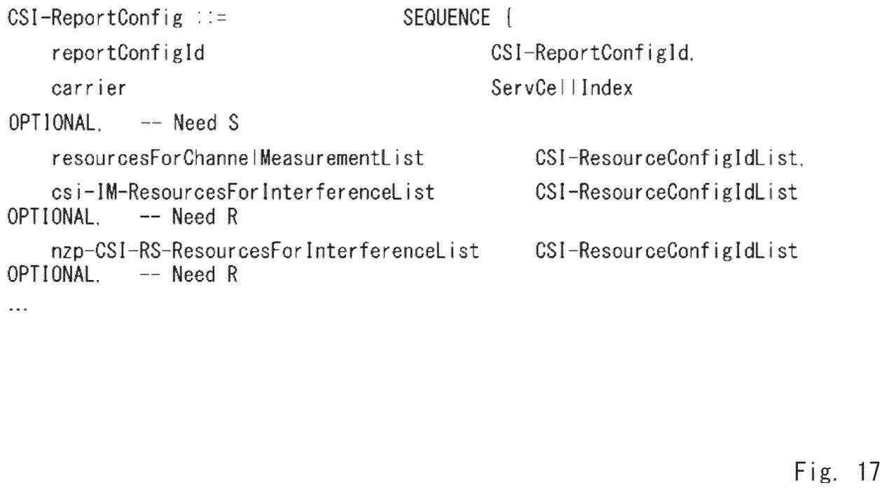

FIG. 17 shows an example in which a CSI report configuration is transmitted from the base station 5 to the UE 3. As shown in the figure, in this example the CSI-ReportConfig (previously described with reference to FIG. 9) includes CSI-ReportConfigId and ServCellIndex (used to identify a serving cell) information elements. Advantageously, in the present example, the CSI Report Configuration (CSI-ReportConfig) can also include an indication of a list of resources for channel measurement (resourcesForChannelMeasurementList), and a list of CSI IM resources for interference measurement (csi-IM-ResourcesForInterferenceList), indicated by respective information elements (in this example, CSI-ResourceConfigIdList information elements). The CSI Report Configuration (CSI-ReportConfig) can also include an indication of a list of NZP CSI RS resources for interference measurement, indicated by a corresponding information element (in this example, a CSI-ResourceConfigIdList information element).

Each element of the CSI resource configuration ID list (indicated by the CSI-ResourceConfigIdList information element) corresponds to a spatial adaptation pattern for use by the base station 5. Beneficially, the channel measurement resource and interference measurement resource can be ordered in a one-to-one mapping for each spatial adaptation pattern. In other words, the CSI resource configuration ID list can be used to indicate one or more channel measurement resources and one or more interference measurement resources for use with a particular spatial adaptation pattern.

### Selection of CSI

The UE 3 may be configured to select a set of CSI to be reported to the base station 5. Advantageously, the UE 3 may be configured to report CSI corresponding a selected number of spatial adaptation patterns.

In the present example, the UE 3 is configured to select a set of CSI include in a CSI report for transmission from the UE 3 to the base station 5. The UE 3 may select a set of CSI based on the corresponding spatial adaptation patterns. The UE 3 may include an indication of the corresponding spatial adaptation patterns when transmitting the CSI report to the base station 5. For example, the UE 3 could include an index of the tables illustrated in FIG. 16 (index j), that indicates a spatial adaptation pattern (e.g. j=3, indicating a particular set of 4 antenna ports used to transmit the CSI-RS), in the CSI report transmitted to the base station 5. The number of bits used to indicate the corresponding spatial adaptation patterns may be determined based on the number of rows of the table illustrated in FIG. 16.

The UE 3 may be configured to determine to select the best m CSIs to report to the base station 5 in the measurement report. The value of m may be configurable by the base station (e.g. using any suitable transmission from the base station 5 to the UE 3).

Particularly advantageous methods of reducing the overhead of the CSI reports transmitted from the UE 3 to the base station 5 will now be described. Advantageously, a multiple CSI NES parameter (e.g. ‘multiCSI-NES’) can be configured as ‘enabled’ (e.g. by setting a corresponding bit to ‘1’) or ‘disabled’ (e.g. by setting a corresponding bit to ‘0’), and is used to indicate whether the CSI report includes multiple CSI and NES is used.

In a first alternative, if the multiple CSI NES parameter is set as ‘enabled’, then for the m reported CSI, absolute 4-bit values could be used to report the first CSI, and 2-bit differential CQI values could be used for the remaining m−1 CSIs. For example, when m is equal to 3, a 4 bit field could be used to report the first CSI, and 2 bit differential fields could be used to indicate the CSI for the second and third CSI with respect to the absolute value indicated using the 4 bit field for the first CSI. Advantageously, therefore, the use of the 2 bit differential fields enables the overhead for the reporting of multiple CSI to be reduced.

In a second alternative, when in an NES mode, differential values for the CSI may be used (e.g. using 2-bit fields), where the differential indication is with respect to CSI for the previous (e.g. immediate/latest) non-NES duration. Beneficially, therefore, the use of the 2 bit differential fields enables the overhead for the reporting of multiple CSI to be reduced.

The use of differential indications (which may also be referred to as ‘delta indications’) for the CSI may also be applied for spatial adaptation based on L1-SINR, to report differential L1-SINR values (for example by indicating a difference with respect to the most recent non-NES L1-SINR value).

### Transmission Power

The transmission power (or PSD) of transmissions by the base station 5 may be reduced in order to achieve energy savings in the network. An SSB reference power is defined in SIB1 (using ss-PBCH-BlockPower). A power control offset (powerControlOffsetSS) defines a power offset between the (NZP) CSI-RS and the SSB. A further power control offset (powerControlOffset) defines a power offset between the PDSCH and the (NZP) CSI-RS. These power control offsets can be semi-statically configured using corresponding RRC signalling. The power control offset configurations for the PDSCH and CSI-RS may be BWP-specific. The base station 5 may be configured to change (adapt or adjust) the PDSCH transmission power in order to achieve energy savings.

The transmission power of PSD of downlink signals and channels can be adapted dynamically, by modifying the corresponding configuration that is transmitted to the UE 3 (e.g. based on power offsets that account for potential power adaptation) and/or the feedback that is transmitted from the UE 3 to the base station 5 (e.g. the CSI report) to assist in the NES method performed by the base station 5. These modified configurations may applicable to transmission of PDSCH, CSI-RS, DMRS, broadcast channels and signals (e.g. SSB, SI and paging transmissions), and any other suitable transmissions.

Particularly advantageous methods for configuring power offset values between the PDSCH and CSI-RS are described below.

### UE Capability

As described above, the base station 5 may be configured to use a first spatial adaptation for NES (e.g. using a first configuration set of antenna elements), and then use a second spatial adaptation for NES (e.g. using a second configuration set of antenna elements). When the base station 5 transitions from the first spatial adaptation to the second spatial adaptation, there may be a transition time for switching between the spatial adaptations. Similarly, there may be a transition time between low and high power levels for transmissions by the base station 5, due to the time taken at the base station 5 to scale the power level up or down. Transition to an energy saving mode may require a longer transition time than a transition from a low power level to a high power level. These transition times can have an impact on measurements and packet reception at the UE 3. The UE 3 may need to perform reconfiguration to measure the CSI-RS (or receive the PDSCH) transmitted using the second spatial adaptation (or the new power level). Advantageously, in the present example, the UE 3 can transmit, to the base station 5, an indication of the reconfiguration time period in which the UE 3 performs the reconfiguration.

The UE 3 may be configured to transmit, to the base station 5, an indication of the transition time per spatial pattern (per adaptation). For example, the UE 3 may be configured to transmit an indication of a list of transition times to the base station, e.g. in the format (X, Y) μs, where X μs is the transition time needed to reconfigure for measurement of CSI-RS (or reception of PDSCH) transmitted using a first configuration of antenna ports, and Y μs is the transition time needed to reconfigure for measurement of CSI-RS transmitted using a second configuration of antenna ports. The indication of the transition time may be referred to as ‘capability information’. Advantageously, therefore, upon reception of the transition time information, the base station 5 is able to perform control, based on the transition times indicated by the UE 3, when transmitting the CSI-RS or PDSCH, increasing the reliability of communication in the system.

The UE 3 may be configured to indicate the transition time per antenna port configuration (e.g. per row of the tables illustrated in FIG. 16). The UE 3 may include the information in any suitable transmission transmitted from the UE 3 to the base station. The transition time may be indicated explicitly (e.g. by explicitly indicating the transition time in μs), but could also be indicated, for example, using a lookup table and a corresponding index. The UE 3 may be configured to omit reporting of the transition time needed for reconfiguration for a particular NES adaptation, in which case the base station 5 may be configured to determine that the transition time for that NES adaptation is negligible.

### DCI and Multiple CSI

In the present example, the base station 5 is configured to transmit an indication of a spatial adaptation pattern update and power change using group-common or UE-specific DCI. It will be appreciated that group-common DCI is DCI that is transmitted and intended for reception by a particular group of UEs 3.

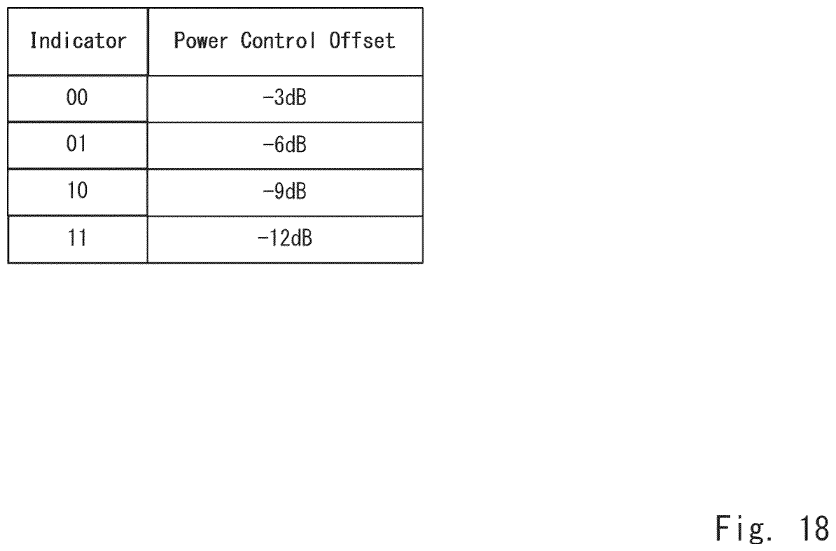

Advantageously, the present example provides a mechanism for supporting co-ordination and/or joint selection of the best spatial adaptation pattern for a group of UEs 3, via multiple CSI in a joint CSI report. Beneficially, multiple PDSCH or CSI-RS transmission power settings may be separately or jointly indicated to the group of UEs 3 with spatial element adaptation information using lookup tables and transmission of a corresponding index (or indices). FIG. 18 shows an example of a table that could be used to indicate the power control offset (e.g. used for transmission of the CSI-RS for measurement by the UEs 3) to the UEs 3. As illustrated in FIG. 18, in this example each power control offset value is indicated by a corresponding 2-bit value. However, it will be appreciated that a number of bits other than two could be used to indicate the power control offset value, and that the particular values for the power control offsets are not limited to those illustrated in FIG. 18.

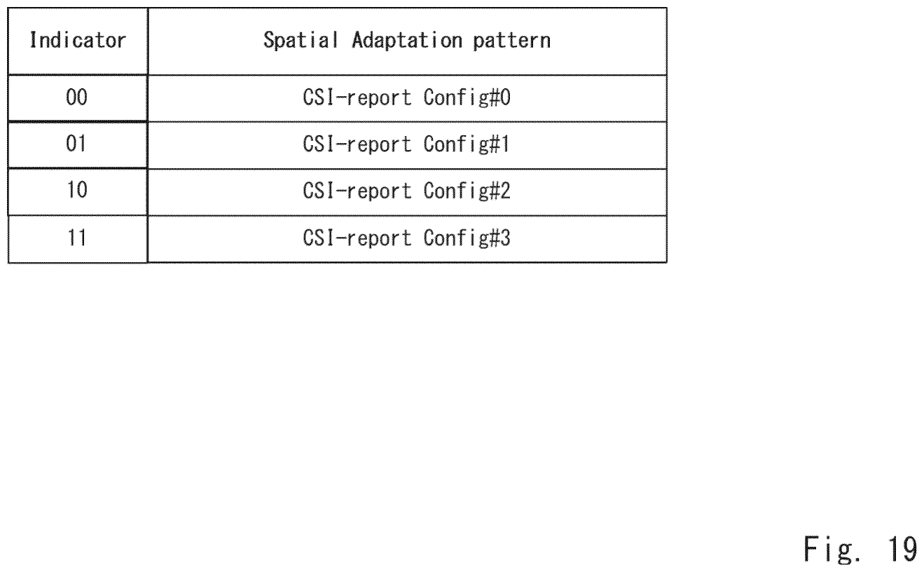

Similarly, FIG. 19 shows an example of a table that could be used to indicate the spatial adaptation patterns (e.g. used for the transmission of the CSI-RS, for measurement by the UEs 3) to the UEs 3. As illustrated in FIG. 18, in this example each spatial adaptation pattern is indicated by a corresponding 2-bit value. However, it will be appreciated that a number of bits other than two could be used to indicate the spatial adaptation pattern.

### PDSCH Power Offset

### PDSCH DCI Grant

Examples in which an indication of the power control offset/spatial adaptation pattern is included in the PDSCH DCI grant (or DL grant) will now be described. The UE 3 may be configured to apply the received power control offset and/or spatial adaptation pattern autonomously when the UE 3 enters or re-enters an NES mode in the time domain based on cell DTX/DRX when spatial and/or power domain NES is enabled. i.e. the UE 3 continues to use received power control offset and/or spatial adaptation pattern for the next NES time duration although resuming to a regular power control offset and/or spatial adaptation pattern during non-NES time period.

In a first option, the UE 3 is configured to apply a received power control offset and/or spatial adaptation pattern only for the corresponding scheduled PDSCH. For every other DL/PDSCH transmission, the UE 3 continues to use (e.g. receive or perform measurements based on) a regular (or previously configured) power control offset and/or spatial adaptation pattern.

In a second option, the UE 3 is configured to apply the indicated power control offset and/or spatial adaptation pattern for all PDSCH transmission (e.g. until a further new value is provided), beginning with the scheduled PDSCH transmission.

In a third option, the network (e.g. via the base station 5) indicates (e.g. explicitly using an independent or dedicated bit) whether the power control offset and/or spatial adaptation pattern is to be applied for only the scheduled PDSCH, or also for subsequent PDSCH transmitted after the scheduled PDSCH.

Advantageously, therefore, the UE 3 is able to determine for which PDSCH the power control offset and/or spatial adaptation pattern indicated in a PDSCH DCI grant is to be applied.

### Group Common DCI

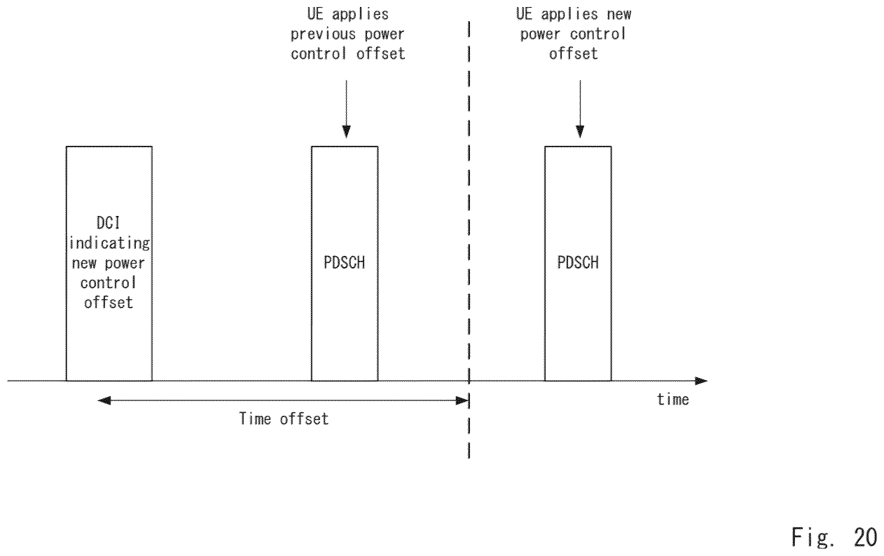

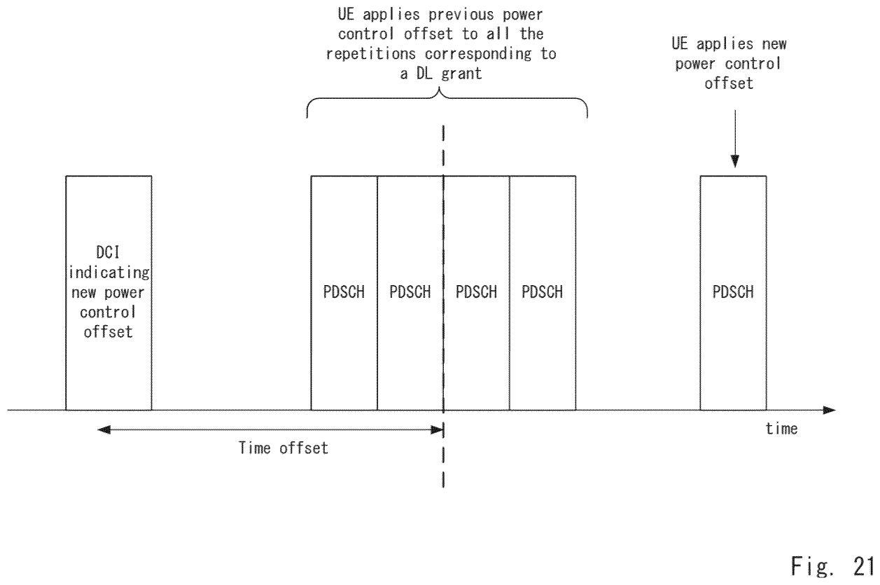

Examples in which an indication of the power control offset/spatial adaptation pattern is included in group common DCI will now be described, with reference to FIG. 20 and FIG. 21.

In a first option, the network indicates (e.g. via the base station 5), a time offset after which the UE 3 is to apply the indicated power control offset and/or spatial adaptation pattern (e.g. receive or perform measurements of a signal based on). The time offset may also be referred to as a time delay, or a timer. For example, FIG. 20 shows an example in which the UE 3 receives DCI indicating a new power control offset (and/or spatial adaptation pattern). The time offset is an offset from the time at which the UE 3 receives the DCI. As shown in FIG. 20, in this example the UE 3 receives PDSCH before the end of the time offset (i.e. within a time window between a time t at which the UE receives the DCI, and a time t+the time offset). Since the PDSCH is received before the end of the time offset, the UE 3 does not use the new power control offset (and/or spatial adaptation pattern) received in the DCI. The UE 3 then receives a further PDSCH after the end of the time offset, and uses the new power control offset and/or spatial adaptation pattern received in the DCI.

The indication of the time after which the UE 3 is to use the indicated power control offset (and/or spatial adaptation pattern) may be indicated to the UE 3 by the base station 5 using any suitable transmission (e.g. in the DCI). Alternatively, the time offset may be preconfigured at the UE 3, in which case the time offset need not be transmitted to the UE 3 by the base station 5.

If a PDSCH transmission is ongoing at the time at which the UE 3 is to apply the indicated power control offset/spatial adaptation pattern, the UE 3 applies the indicated power control offset/spatial adaptation pattern after the end of the set of PDSCH transmissions associated with the same DL grant. For example, FIG. 21 shows an example in which the UE 3 receives the DCI indicating the new power control offset from the base station 5, and then receives PDSCH repetitions corresponding to a single DL grant. The UE 3 does not use the new power control offset (and/or spatial adaptation pattern) indicated in the DCI for the repetitions corresponding to the DL grant, even though some of the repetitions are receives after the end of the time offset. The UE 3 then receives a further PDSCH that does not correspond to the same DL grant, and applies the new power control offset (and/or spatial adaptation pattern) indicated in the DCI.

### Transmission Configuration Indicator (TCI) States

A beam for a target channel/signal (e.g., PDSCH, PDCCH, CSI-RS) to be received by the UE 3 can be indicated by transmitting TCI to the UE 3 from the base station 5. The TCI comprises, for example, a source reference signal and an intended Quasi Co-Location (QCL) type to be applied. For example, the base station 5 may schedule resources on a PDSCH to the UE 3 using DCI that indicates a TCI to be used for reception of the PDSCH. The UE 3 can then configure its beamforming parameters based on the indicated TCI and receive the PDSCH accordingly. For a PDCCH (or CSI-RS), a separate signal may be used for the TCI (independently of the PDSCH).

A power control offset and/or spatial adaptation pattern may be applied at a single TRP, rather than at all of the TRPs of a cell. Examples in which an indication is provided to the UE 3 of which transmissions a power control offset/spatial adaptation pattern are applicable to will now be described.

In a first example, when the network provides an indication of a power control offset and/or spatial adaptation pattern to the UE 3 within a DL grant, the UE 3 is configured to apply the power control offset and/or spatial adaptation pattern only to the TCI states associated with the PDSCH.

In a second example, when the network provides an indication of a power control offset and/or spatial adaptation pattern to the UE 3 within a group-common DCI, the network also provides an indication of the TCI states for which the power control offset and/or spatial adaptation patter is applicable for.

In a third example, the UE 3 is configured to apply a power control offset and/or spatial adaptation pattern to the TCI state that is associated with the DCI within which the indication of the power control offset and/or spatial adaptation pattern is provided by the network.

In a fourth example, the network configures (or associates) each power control offset/spatial adaptation pattern value with a TCI state. Therefore, when the network changes the power control offset/spatial adaptation pattern value, it changes the TCI state of the UE 3 (used by the UE 3 for DL reception).

Advantageously, therefore, the UE 3 is able to identify which transmissions the indicated power control offset and/or spatial adaptation pattern is applicable to.

### User Equipment

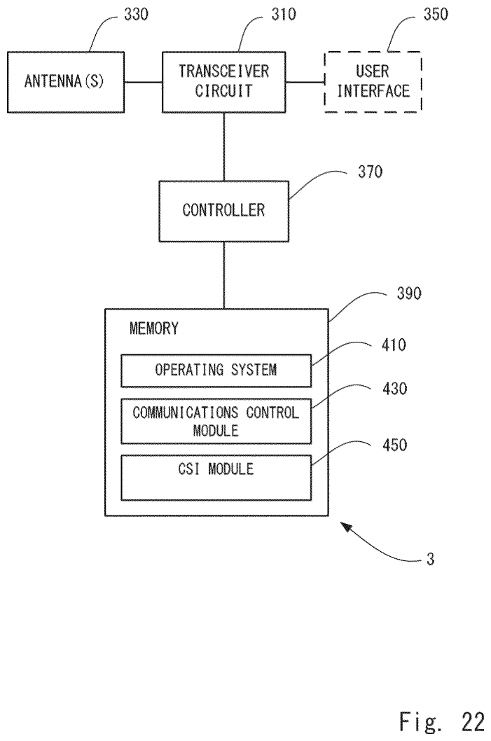

FIG. 22 is a schematic block diagram illustrating the main components of a UE 3 as shown in FIG. 1.

As shown, the UE 3 has a transceiver circuit 310 that is operable to transmit signals to and to receive signals from a base station 5 via one or more antenna 330 (e.g., comprising one or more antenna elements). The UE 3 has a controller 370 to control the operation of the UE 3. The controller 370 is associated with a memory 390 and is coupled to the transceiver circuit 310. Although not necessarily required for its operation, the UE 3 might, of course, have all the usual functionality of a conventional UE 3 (e.g. a user interface 350, such as a touch screen/keypad/microphone/speaker and/or the like for, allowing direct control by and interaction with a user) and this may be provided by any one or any combination of hardware, software, and firmware, as appropriate. Software may be pre-installed in the memory 390 and/or may be downloaded via the communication system or from a removable data storage device (RMD), for example.

The controller 370 is configured to control overall operation of the UE 3 by, in this example, program instructions or software instructions stored within memory 390. As shown, these software instructions include, among other things, an operating system 410, a communications control module 430, and a CSI module 450.

The communications control module 430 is operable to control the communication between the UE 3 and one or more its serving base stations 5 (and other communication devices connected to the base station 5, such as further UEs and/or core network nodes). The communications control module 430 is configured for the overall handling uplink communications via associated uplink channels (e.g. via a physical uplink control channel (PUCCH), random access channel (RACH), and/or a physical uplink shared channel (PUSCH)) including both dynamic and semi-static signalling (e.g., SRS). The communications control module 430 is also configured for the overall handling of receipt of downlink communications via associated downlink channels (e.g. via a physical downlink control channel (PDCCH) and/or a physical downlink shared channel (PDSCH)) including both dynamic and semi-static signalling (e.g., CSI-RS). The communications control module 430 is responsible, for example: for determining where to monitor for downlink control information (e.g., the location of CSSs/USSs, CORESETs, and associated PDCCH candidates to monitor); for determining the resources to be used by the UE 3 for transmission/reception of UL/DL communications (including interleaved resources and resources subject to frequency hopping); for managing frequency hopping at the UE side; for determining how slots/symbols are configured (e.g., for UL, DL or SBFD communication, or the like); for determining which one or more bandwidth parts are configured for the UE 3; for determining how uplink transmissions should be encoded; for applying any SBFD specific communication configurations appropriately; and the like. The CSI module 450 may be configured to control communications in accordance with any of the CSI-RS related methods described above (for example, to receive and measure CSI-RS transmitted by the base station 5, and to transmit a corresponding measurement report to the base station 5).

### Base Station

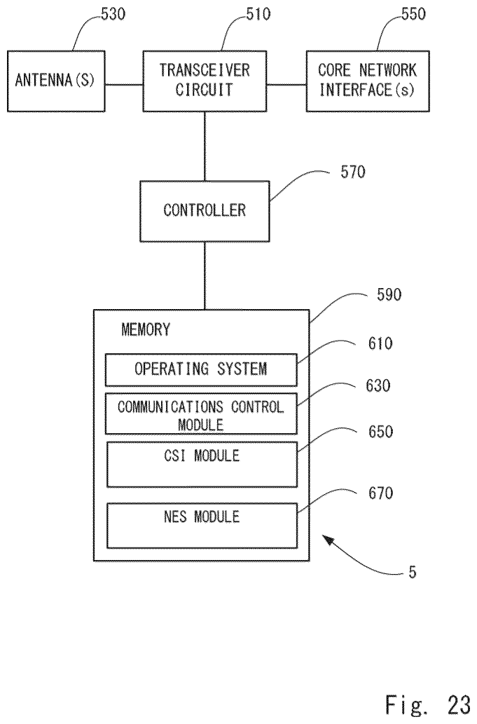

FIG. 23 is a schematic block diagram illustrating the main components of the base station 5 for the communication system 1 shown in FIG. 1. As shown, the base station 5 has a transceiver circuit 510 for transmitting signals to and for receiving signals from the communication devices (such as UEs 3) via one or more antenna 530 (e.g. a single or multi-panel antenna array/massive antenna), and a core network interface 550 (e.g. comprising the N2, N3 and other reference points/interfaces) for transmitting signals to and for receiving signals from network nodes in the core network 7. Although not shown, the base station 5 may also be coupled to other base stations via an appropriate interface (e.g. the so-called ‘Xn’ interface in NR). The base station 5 has a controller 570 to control the operation of the base station 5. The controller 570 is associated with a memory 590. Software may be pre-installed in the memory 590 and/or may be downloaded via the communications network 1 or from a removable data storage device (RMD), for example. The controller 570 is configured to control the overall operation of the base station 5 by, in this example, program instructions or software instructions stored within memory 590.

As shown, these software instructions include, among other things, an operating system 610, a communications control module 630, a CSI module 650 and an NES module 670.

The communications control module 630 is operable to control the communication between the base station 5 and UEs 3 and other network entities that are connected to the base station 5. The communications control module 630 is configured for the overall control of the reception and decoding of uplink communications, via associated uplink channels (e.g. via a physical uplink control channel (PUCCH), a random-access channel (RACH), and/or a physical uplink shared channel (PUSCH)) including both dynamic and semi-static signalling (e.g., SRS). The communications control module 630 is also configured for the overall handling the transmission of downlink communications via associated downlink channels (e.g. via a physical downlink control channel (PDCCH) and/or a physical downlink shared channel (PDSCH)) including both dynamic and semi-static signalling (e.g., CSI-RS). The communications control module 630 is responsible for managing full duplex (e.g., SBFD) communication including, where appropriate, the segregation of UL and DL communication via different physical antenna elements. The communications control module 630 is responsible, for example: for determining where to configure the UE 3 to monitor for downlink control information (e.g., the location of CSSs/USSs, CORESETs, and associated PDCCH candidates to monitor); for determining the resources to be scheduled for UE transmission/reception of UL/DL communications (including interleaved resources and resources subject to frequency hopping); for managing frequency hopping at the base station side; for configuring slots/symbols appropriately (e.g., for UL, DL or SBFD communication, or the like); for configuring one or more bandwidth parts for the UE 3; for providing related configuration signalling to the UE 3; and the like. The communications control module 630 may be configured to control communications in accordance with any of the methods described above. The CSI module 650 may be configured to control communications in accordance with any of the CSI-RS related methods described above (for example, to transmits a CSI-RS, and to receive a corresponding measurement report from the UE 3). The NES module 670 may be configured to control communications in accordance with any of the NES related methods described above (e.g. to configure a power control offset and/or spatial adaptation pattern).

### Core Network Node/Function

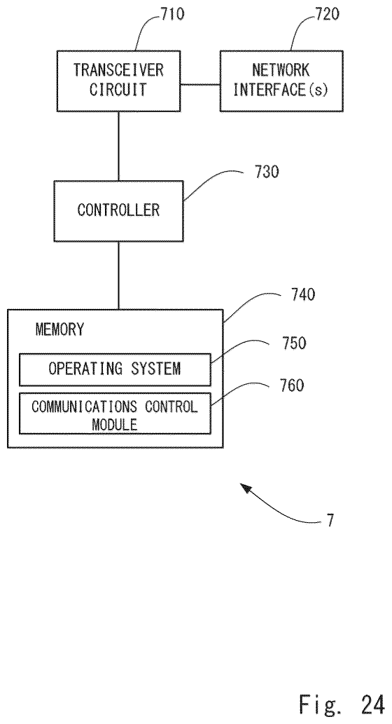

FIG. 24 is a block diagram illustrating the main components of a core network node or function, such as the AMF, CPF, the UPF, the SMF or OAM. As shown, the core network function includes a transceiver circuit 710 which is operable to transmit signals to and to receive signals from other nodes (including the UE 3, the base station 5, and other core network nodes) via a network interface 720. A controller 730 controls the operation of the core network function in accordance with software stored in a memory 740. The software may be pre-installed in the memory 74 and/or may be downloaded via the telecommunication network 1 or from a removable data storage device (RMD), for example. The software includes, among other things, an operating system 750, and a communications control module 760.

The communications control module 760 is responsible for handling (generating/sending/receiving) signalling between the core network function and other nodes, such as the UE 3, the base station 5, and other core network nodes.

The communications control module 760 may be configured to perform control of communications in accordance with any of the methods described above.

### Modifications and Alternatives

As those skilled in the art will appreciate, a number of modifications and alternatives can be made to the above example embodiments whilst still benefiting from the disclosure embodied therein.

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied as a signal over a computer network, or on a recording medium. Further, the functionality performed by part, or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.). A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine type communication applications.

| Service Area | MTC applications |
|---|---|
| Security | Surveillance systems |
| | Backup for landline |
| | Control of physical access |
| | (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/Control | Sensors |
| | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and example embodiments described in the present document. Needless to say, these technical ideas and example embodiments are not limited to the above-described UE and various modifications can be made thereto.

Various other modifications will be apparent to those skilled in the art and will not be described in further detail here.

For example, the whole or part of the exemplary embodiments disclosed above can be described as, but not limited to, the following supplementary notes.

### (Supplementary Note 1)

A method performed by an access network node, the method comprising:
transmitting, to a user equipment, UE, in a cell provided by the access network node, report configuration information comprising an indication of one or more reference signal resources for measurement of a reference signal by the UE;
wherein each of the one or more reference signal resources is associated with a respective one of a set of energy saving configurations for transmission of the reference signal by the access network node; and wherein the method further comprises:
transmitting the reference signal; and
receiving, from the UE, a measurement report generated based on the report configuration information.

### (Supplementary Note 2)

The method according to supplementary note 1, wherein the set of energy saving configurations comprises:
a set of power levels for transmission of the reference signal by the access network node; or
a set of spatial configurations for transmission of the reference signal by the access network node.

### (Supplementary Note 3)

The method according to supplementary note 2, wherein the report configuration information comprises an indication of one or both of:
a spatial configuration for transmission of the reference signal by the access network node; or
a reference signal pattern or reference signal measurement resource associated with the spatial configuration.

### (Supplementary Note 4)

The method according to supplementary note 2 or 3, wherein each spatial configuration corresponds to a respective set of antenna elements for transmission of the reference signal by the access network node.

### (Supplementary Note 5)

The method according to any one of supplementary notes 3 to 4, wherein the report configuration information comprises an index that indicates at least one of the spatial configuration or the respective reference signal resources.

### (Supplementary Note 6)

The method according to supplementary note 5, the method further comprising transmitting, to the UE, downlink control information, DCI, comprising the index.

### (Supplementary Note 7)

The method according to supplementary note 5 or 6, wherein the method further comprises transmitting, to the UE, a table that provides an indication of a mapping between the index and at least one of:
the corresponding spatial configuration for transmission of the reference signal by the access network node; or
the corresponding reference signal resources.

### (Supplementary Note 8)

The method according to any preceding supplementary note, wherein the one or more reference signal resources comprises at least one of:
one or more non-zero power, NZP, channel state information reference signal, CSI-RS, measurement resources;
one or more CSI interference measurement, IM, resources; or
one or more NZP CSI-RS resources.

### (Supplementary Note 9)

The method according to any preceding supplementary note, wherein the method comprises transmitting the report configuration information to the UE as part of:
network energy saving, NES, configuration information;
a channel state information, CSI, report configuration;
radio resource control, RRC, reconfiguration information; or system information broadcast in the cell.

### (Supplementary Note 10)

The method according to any preceding supplementary note, wherein the reference signal is a CSI-RS, and the access network node transmits the report configuration information to the UE in a CSI report configuration.

### (Supplementary Note 11)

The method according to supplementary note 10, wherein the reference signal resources correspond to CSI-RS measurement resources.

### (Supplementary Note 12)

The method according to any preceding supplementary note, wherein the report configuration information comprises at least one of:
an indication of a plurality of resources for measurement of a channel; or an indication of a plurality of resources for interference measurement;
wherein each of the resources for measurement of a channel or the resources for interference measurement are associated with a respective spatial configuration for transmission of the reference signal by the access network node.

### (Supplementary Note 13)

A method performed by a user equipment, UE, the method comprising:
receiving, from an access network node, report configuration information comprising an indication of one or more reference signal resources for measurement of a reference signal by the UE;
wherein each of the one or more reference signal resources is associated with a respective one of a set of energy saving configurations for transmission of the reference signal by the access network node; and wherein the method further comprises:
performing a measurement of the reference signal; and
transmitting, to the access network node, a measurement report generated based on the report configuration information.

### (Supplementary Note 14)

The method according to supplementary note 13, wherein the set of energy saving configurations comprises:
a set of power levels for transmission of the reference signal by the access network node; or
a set of spatial configurations for transmission of the reference signal by the access network node.

### (Supplementary Note 15)

The method according to supplementary note 14, wherein the report configuration information comprises an indication of one or both of:
a spatial configuration for transmission of the reference signal by the access network node; or
a reference signal pattern or reference signal measurement resource associated with the spatial configuration.

### (Supplementary Note 16)

The method according to supplementary note 14 or 15, wherein each spatial configuration corresponds to a respective set of antenna elements for transmission of the reference signal by the access network node.

### (Supplementary Note 17)

The method according to supplementary notes 15 or 16, wherein the report configuration information comprises an index that indicates at least one of the spatial configuration or the respective reference signal resources.

### (Supplementary Note 18)

The method according to supplementary note 17, the method further comprising receiving, from the access network node, downlink control information, DCI, comprising the index.

### (Supplementary Note 19)

The method according to supplementary note 17 or 18, wherein the method further comprises receiving, from the access network node, a table that provides an indication of a mapping between the index and at least one of:
the corresponding spatial configuration for transmission of the reference signal by the access network node; or
the corresponding reference signal resources.

### (Supplementary Note 20)

The method according to any one of supplementary notes 13 to 19, wherein the one or more reference signal resources comprises at least one of:
one or more non-zero power, NZP, channel state information reference signal, CSI-RS, measurement resources;
one or more CSI interference measurement, IM, resources; or
one or more NZP CSI-RS resources.

### (Supplementary Note 21)

The method according to any one of supplementary notes 13 to 20, wherein the method comprises receiving the report configuration information from the access network node as part of:
network energy saving, NES, configuration information;
a channel state information, CSI, report configuration;
radio resource control, RRC, reconfiguration information; or system information broadcast in the cell.

### (Supplementary Note 22)

The method according to any one of supplementary notes 13 to 21, wherein the reference signal is a CSI-RS, and the UE receives the report configuration information from the access network node in a CSI report configuration.

### (Supplementary Note 23)

The method according to supplementary note 22, wherein the reference signal resources correspond to CSI-RS measurement resources.

### (Supplementary Note 24)

The method according to any one of supplementary notes 13 to 23, wherein the report configuration information comprises at least one of:
an indication of a plurality of resources for measurement of a channel; or an indication of a plurality of resources for interference measurement;
wherein each of the resources for measurement of a channel or the resources for interference measurement are associated with a respective spatial configuration for transmission of the reference signal by the access network node.

### (Supplementary Note 25)

The method according to any one of supplementary notes 13 to 24, wherein the measurement report transmitted to the access network node comprises an indication of one or more CSI; and an indication of the of energy saving configuration associated with each of the one or more CSI.

### (Supplementary Note 26)

A method of an access network node, the method comprising:
transmitting, to a user equipment, UE, in a cell provided by the access network node, report configuration information comprising an indication of a number of channel state information, CSI, or signal to interference and noise ratio, SINR, values to be included in a measurement report to be transmitted to the access network node by the UE;
wherein each of the CSI or SINR values is associated with a respective one of a set of energy saving configurations for transmission of a reference signal by the access network node; and wherein the method further comprises:
receiving, from the UE, a measurement report generated based on the report configuration information.

### (Supplementary Note 27)

The method according to supplementary note 26, wherein the set of energy saving configurations comprises:
a set of power levels for transmission of the reference signal by the access network node; or
a set of spatial configurations for transmission of the reference signal by the access network node.

### (Supplementary Note 28)

The method according to supplementary note 27, wherein each spatial configuration corresponds to a respective set of antenna elements for transmission of the reference signal by the access network node.

### (Supplementary Note 29)

The method according to any one of supplementary notes 26 to 28, wherein the measurement report received from the UE comprises an indication of the energy saving configuration associated with each CSI or SINR value included in the measurement report.

### (Supplementary Note 30)

The method according to any one of supplementary notes 27 to 29, wherein the measurement report includes:
an indication of a first CSI or SINR value, indicated using a first number of bits; and
an indication of a second CSI or SINR value, indicated using a second number of bits;
wherein the second number of bits is smaller than the first number of bits; and
wherein the second CSI or SINR value is indicated by indicating a difference between the second CSI or SINR value and the first CSI or SINR value.

### (Supplementary Note 31)

The method according to any one of supplementary notes 26 to 29, wherein the measurement report includes an indication of a first CSI or SINR value, indicated using a first number of bits;
wherein the first CSI or SINR value is associated with an energy saving configuration for transmission of the reference signal by the access network node; and
wherein the first CSI or SINR value is indicated by indicating a difference between the first CSI or SINR value and a CSI or SINR value associated with a reference signal transmitted by the base station before the base station transmitted the reference signal using the energy saving configuration.

### (Supplementary Note 32)

A method of user equipment, UE, the method comprising:
receiving, from an access network node, report configuration information comprising an indication of a number of channel state information, CSI, or signal to interference and noise ratio, SINR, values to be included in a measurement report to be transmitted to the access network node by the UE;
wherein each of the CSI or SINR values is associated with a respective one of a set of energy saving configurations for transmission of a reference signal by the access network node; and wherein the method further comprises:
transmitting, to the access network node, a measurement report generated based on the report configuration information.

### (Supplementary Note 33)

The method according to supplementary note 32, wherein the set of energy saving configurations comprises:
a set of power levels for transmission of the reference signal by the access network node; or
a set of spatial configurations for transmission of the reference signal by the access network node.

### (Supplementary Note 34)

The method according to supplementary note 33, wherein each spatial configuration corresponds to a respective set of antenna elements for transmission of the reference signal by the access network node.

### (Supplementary Note 35)

The method according to any one of supplementary notes 32 to 34, wherein the measurement report transmitted to the access network node by the UE comprises an indication of the energy saving configuration associated with each CSI or SINR value included in the measurement report.

### (Supplementary Note 36)

The method according to any one of supplementary notes 32 to 35, wherein the method further comprises determining the CSI or SINR value to include in the measurement report for transmitting to the access network node.

### (Supplementary Note 37)

The method according to any one of supplementary notes 32 to 36, wherein the measurement report includes:
an indication of a first CSI or SINR value, indicated using a first number of bits; and
an indication of a second CSI or SINR value, indicated using a second number of bits;
wherein the second number of bits is smaller than the first number of bits; and
wherein the second CSI or SINR value is indicated by indicating a difference between the second CSI or SINR value and the first CSI or SINR value.

### (Supplementary Note 38)

The method according to any one of supplementary notes 32 to 36, wherein the measurement report includes an indication of a first CSI or SINR value, indicated using a first number of bits;
wherein the first CSI or SINR value is associated with an energy saving configuration for transmission of the reference signal by the access network node; and
wherein the first CSI or SINR value is indicated by indicating a different between the first CSI or SINR value and a CSI or SINR value associated with a reference signal transmitted by the base station before the base station transmitted the reference signal using the energy saving configuration.

### (Supplementary Note 39)

A method performed by an access network node, the method comprising:
transmitting, to a user equipment, UE, in a cell provided by the access network node, energy saving configuration information comprising an indication of one or more energy saving configurations for transmission of a reference signal by the access network node; and
receiving, from the UE, UE capability information comprising an indication of one or more transition times, wherein each transition time corresponds to a time duration for the UE to transition a state in which the UE is configured for measuring the reference signal transmitted by the access network node based on a respective one of the one or more energy saving configurations.

### (Supplementary Note 40)

The method according to supplementary note 39, wherein the set of energy saving configurations comprises:
a set of power levels for transmission of the reference signal by the access network node; or
a set of spatial configurations for transmission of the reference signal by the access network node.

### (Supplementary Note 41)

The method according to 40, wherein each spatial configuration corresponds to a respective set of antenna elements for transmission of the reference signal by the access network node.

### (Supplementary Note 42)

A method performed by a user equipment, UE, the method comprising:
receiving, from an access network node, energy saving configuration information comprising an indication one or more energy saving configurations for transmission of a reference signal by the access network node; and
transmitting, to the access network node, UE capability information comprising an indication of one or more transition times, wherein each transition time corresponds to a time duration for the UE to transition a state in which the UE is configured for measuring the reference signal transmitted by the access network node based on a respective one of the one or more energy saving configurations.

### (Supplementary Note 43)

A method performed by an access network node, the method comprising:
transmitting, to a user equipment, UE, in a cell provided by the access network node, transmission configuration information comprising an indication of one or more energy saving configurations for transmission of a reference signal or a physical downlink shared channel, PDSCH, by the access network node; and
transmitting the reference signal or the PDSCH;
wherein the transmission configuration information comprises at least one of:
an indication of a power offset used for transmission of the reference signal or the PDSCH; or
an indication of a spatial configuration used for transmission the reference signal or the PDSCH.

### (Supplementary Note 44)

The method according to supplementary note 43, wherein the spatial configuration corresponds to a configuration of set of antenna elements for transmission of the reference signal or the PDSCH by the access network node.

### (Supplementary Note 45)

The method according to supplementary note 43 or 44, wherein the indication of one or more energy saving configurations for transmission of the reference signal or the PDSCH comprises an index that indicates one or both of the power offset used for transmission of the reference signal or the PDSCH, or the spatial configuration used for transmission the reference signal or the PDSCH.

### (Supplementary Note 46)

The method according to supplementary note 45, wherein the index is associated with one or more corresponding lookup tables that provide a mapping between one or both of: the value of the index and the power offset used for transmission of the reference signal or the PDSCH; the value of the index and the spatial configuration used for transmission the reference signal.

### (Supplementary Note 47)

A method performed by a user equipment, UE, the method comprising:
receiving, from an access network node, transmission configuration information comprising an indication of one or more energy saving configurations for transmission of a reference signal or a physical downlink shared channel, PDSCH, by the access network node; and
receiving the reference signal or the PDSCH;
wherein the transmission configuration information comprises at least one of:
an indication of a power offset used for transmission of the reference signal or the PDSCH by the access network node; or
an indication of a spatial configuration used for transmission the reference signal or the PDSCH by the access network node.

### (Supplementary Note 48)

The method according to supplementary note 47, wherein the spatial configuration corresponds to a configuration of set of antenna elements for transmission of the reference signal or the PDSCH by the access network node.

### (Supplementary Note 49)

The method according to supplementary note 47 or 48, wherein the indication of one or more energy saving configurations for transmission of the reference signal or the PDSCH comprises an index that indicates one or both of the power offset used for transmission of the reference signal or the PDSCH, or the spatial configuration used for transmission the reference signal or the PDSCH.

### (Supplementary Note 50)

The method according to supplementary note 49, wherein the index is associated with one or more corresponding lookup tables that provide a mapping between one or both of: the value of the index and the power offset used for transmission of the reference signal or the PDSCH; or the value of the index and the spatial configuration used for transmission the reference signal.

### (Supplementary Note 51)

The method according to supplementary note 50, wherein the method further comprises obtaining the one or more lookup tables.

### (Supplementary Note 52)

A method performed by an access network node, the method comprising:
transmitting, to a user equipment, UE, in a cell provided by the access network node, downlink control information, DCI, or downlink grant information comprising an indication of an energy saving configuration for transmission of a physical downlink shared channel, PDSCH, by the access network node;
wherein the DCI or downlink grant information comprises an indication of a time after which the UE is to use the indicated energy saving configuration to perform configuration for receiving the PDSCH; and the method further comprises transmitting the PDSCH using the energy saving configuration.

### (Supplementary Note 53)

The method according to supplementary note 52, wherein the energy saving configuration comprises:
a power level or power offset for transmission of the PDSCH by the access network node; or
a spatial configuration for transmission of the PDSCH by the access network node.

### (Supplementary Note 54)

The method according to supplementary note 53, wherein the spatial configuration corresponds to a configuration of antenna elements for transmission of the PDSCH by the access network node.

### (Supplementary Note 55)

The method according any one of supplementary notes 52 to 54, wherein the DCI is group common DCI transmitted to a plurality of UEs by the access network node.

### (Supplementary Note 56)

The method according to any one of supplementary notes 52 to 55, wherein the DCI is group common DCI, and the method comprises transmitting, to the UE, an indication of a transmission configuration indicator, TCI, state associated with the PDSCH for which the UE is to use the indicated energy saving configuration to perform configuration for receiving the PDSCH.

### (Supplementary Note 57)

The method according to anyone of supplementary notes 52 to 55, wherein the method comprises transmitting, to the UE, an indication of a TCI state to indicate the energy saving configuration.

### (Supplementary Note 58)

A method performed by a user equipment, UE, the method comprising:
receiving, from an access network node, downlink control information, DCI, or downlink grant information comprising an indication of an energy saving configuration for transmission of a physical downlink shared channel, PDSCH, by the access network node;
wherein the DCI or downlink grant information comprises an indication of a time after which the UE is to use the indicated energy saving configuration to perform configuration for receiving the PDSCH, or the time after which the UE is to use the indicated energy saving configuration to perform configuration for receiving the PDSCH is preconfigured at the UE; and wherein the method further comprises
performing the configuration for receiving the PDSCH after the indicated time, and receiving the PDSCH.

### (Supplementary Note 59)

The method according to supplementary note 58, wherein the energy saving configuration comprises:
a power level or power offset for transmission of the PDSCH by the access network node; or
a spatial configuration for transmission of the PDSCH by the access network node.

### (Supplementary Note 60)

The method according to supplementary note 59, wherein the spatial configuration corresponds to a configuration of antenna elements for transmission of the PDSCH by the access network node.

### (Supplementary Note 61)

The method according to any one of supplementary notes 58 to 60, wherein the DCI or downlink grant information comprises an indication of a scheduled PDSCH, and the UE only uses the indicated energy saving configuration to perform configuration for receiving the scheduled PDSCH.

### (Supplementary Note 62)

The method according to any one of supplementary notes 58 to 60, wherein the DCI or downlink grant information comprises an indication of one or more PDSCH for which the UE is to use the indicated energy saving configuration to perform configuration for receiving the one or more PDSCH, and the UE only uses the indicated energy saving configuration to perform configuration for receiving the indicated one or more PDSCH.

### (Supplementary Note 63)

The method according to any one of supplementary notes 58 to 62, wherein the DCI is a group common DCI transmitted to a plurality of UEs.

### (Supplementary Note 64)

The method according to any one of supplementary notes 58 to 63, wherein the UE only uses the indicated energy saving configuration to perform configuration for receiving the scheduled PDSCH associated with a particular transmission configuration indicator, TCI, state.

### (Supplementary Note 65)

The method according to any one of supplementary notes 58 to 63, wherein the DCI is group common DCI, and the method comprises receiving, from the access network node, an indication of a TCI state associated with the PDSCH for which the UE is to use the indicated energy saving configuration to perform configuration for receiving the PDSCH.

### (Supplementary Note 66)

The method according to any one of supplementary notes 58 to 65, wherein the method comprises receiving, from the access network node, an indication of a TCI state, and determining the energy saving configuration based on the indicated TCI state.

### (Supplementary Note 67)

An access network node comprising:
means for transmitting, to a user equipment, UE, in a cell provided by the access network node, report configuration information comprising an indication of one or more reference signal resources for measurement of a reference signal by the UE,
wherein each of the one or more reference signal resources is associated with a respective one of a set of energy saving configurations for transmission of the reference signal by the access network node;
means for transmitting the reference signal; and
means for receiving, from the UE, a measurement report generated based on the report configuration information.

### (Supplementary Note 68)

A user equipment, UE, comprising:
means for receiving, from an access network node, report configuration information comprising an indication of one or more reference signal resources for measurement of a reference signal by the UE,
wherein each of the one or more reference signal resources is associated with a respective one of a set of energy saving configurations for transmission of the reference signal by the access network node;
means for performing a measurement of the reference signal; and
means for transmitting, to the access network node, a measurement report generated based on the report configuration information.

### (Supplementary Note 69)

An access network node comprising:
means for transmitting, to a user equipment, UE, in a cell provided by the access network node, report configuration information comprising an indication of a number of channel state information, CSI, or signal to interference and noise ratio, SINR, values to be included in a measurement report to be transmitted to the access network node by the UE;
wherein each of the CSI or SINR values is associated with a respective one of a set of energy saving configurations for transmission of a reference signal by the access network node; and
means for receiving, from the UE, a measurement report generated based on the report configuration information.

### (Supplementary Note 70)

A user equipment, UE, comprising:
means for receiving, from an access network node, report configuration information comprising an indication of a number of channel state information, CSI, or signal to interference and noise ratio, SINR, values to be included in a measurement report to be transmitted to the access network node by the UE;
wherein each of the CSI or SINR values is associated with a respective one of a set of energy saving configurations for transmission of a reference signal by the access network node; and
means for transmitting, to the access network node, a measurement report generated based on the report configuration information.

### (Supplementary Note 71)

An access network node comprising:
means for transmitting, to a user equipment, UE, in a cell provided by the access network node, energy saving configuration information comprising an indication of one or more energy saving configurations for transmission of a reference signal by the access network node; and
means for receiving, from the UE, UE capability information comprising an indication of one or more transition times, wherein each transition time corresponds to a time duration for the UE to transition a state in which the UE is configured for measuring the reference signal transmitted by the access network node based on a respective one of the one or more energy saving configurations.

### (Supplementary Note 72)

A user equipment, UE, comprising:
means for receiving, from an access network node, energy saving configuration information comprising an indication one or more energy saving configurations for transmission of a reference signal by the access network node; and
means for transmitting, to the access network node, UE capability information comprising an indication of one or more transition times, wherein each transition time corresponds to a time duration for the UE to transition a state in which the UE is configured for measuring the reference signal transmitted by the access network node based on a respective one of the one or more energy saving configurations.

### (Supplementary Note 73)

An access network node comprising:
means for transmitting, to a user equipment, UE, in a cell provided by the access network node, transmission configuration information comprising an indication of one or more energy saving configurations for transmission of a reference signal or a physical downlink shared channel, PDSCH, by the access network node; and
means for transmitting the reference signal or the PDSCH;
wherein the transmission configuration information comprises at least one of: an indication of a power offset used for transmission of the reference signal or the PDSCH; or
an indication of a spatial configuration used for transmission the reference signal or the PDSCH.

### (Supplementary Note 74)

A user equipment, UE, comprising:
means for receiving, from an access network node, transmission configuration information comprising an indication of one or more energy saving configurations for transmission of a reference signal or a physical downlink shared channel, PDSCH, by the access network node; and
means for receiving the reference signal or the PDSCH;
wherein the transmission configuration information comprises at least one of:
an indication of a power offset used for transmission of the reference signal or the PDSCH by the access network node; or
an indication of a spatial configuration used for transmission the reference signal or the PDSCH by the access network node.

### (Supplementary Note 75)

An access network node comprising:
means for transmitting, to a user equipment, UE, in a cell provided by the access network node, downlink control information, DCI, or downlink grant information comprising an indication of an energy saving configuration for transmission of a physical downlink shared channel, PDSCH, by the access network node;
wherein the DCI or downlink grant information comprises an indication of a time after which the UE is to use the indicated energy saving configuration to perform configuration for receiving the PDSCH; and means for transmitting the PDSCH using the energy saving configuration.

### (Supplementary Note 76)

A user equipment, UE, comprising:
means for receiving, from an access network node, downlink control information, DCI, or downlink grant information comprising an indication of an energy saving configuration for transmission of a physical downlink shared channel, PDSCH, by the access network node;
wherein the DCI or downlink grant information comprises an indication of a time after which the UE is to use the indicated energy saving configuration to perform configuration for receiving the PDSCH, or the time after which the UE is to use the indicated energy saving configuration to perform configuration for receiving the PDSCH is preconfigured at the UE;
means for performing the configuration for receiving the PDSCH after the indicated time, and means for receiving the PDSCH.

This application is based upon and claims the benefit of priority from Great Britain Patent Application No. 2305562.7, filed on Apr. 14, 2023, the disclosure of which is incorporated herein in its entirety by reference.

### REFERENCE SIGNS LIST

1 COMMUNICATION SYSTEM
3 USER EQUIPMENT
5 BASE STATION
7 CORE NETWORK
9 CELL
10 CONTROL PLANE FUNCTIONS
11 USER PLANE FUNCTIONS
20 EXTERNAL DATA NETWORK
50 DU
60 CU
451 TRANSCEIVER CIRCUIT
453 RU INTERFACE
454 CU INTERFACE
457 CONTROLLER
459 MEMORY
461 OPERATING SYSTEM
463 COMMUNICATIONS CONTROL MODULE
465 F1 MODULE
468 DU-RU MODULE
472 DU MANAGEMENT MODULE
473 UE PROFILE MANAGEMENT MODULE
475 MOBILITY MODULE
551 TRANSCEIVER CIRCUIT
554 DU INTERFACE
555 CU INTERFACE
557 CONTROLLER
559 MEMORY
561 OPERATING SYSTEM
563 COMMUNICATIONS CONTROL MODULE
565 F1 MODULE
566 E1 MODULE
568 N2 MODULE
569 N3 MODULE
571 CU-UP MANAGEMENT MODULE
572 CU-CP MANAGEMENT MODULE
573 UE PROFILE MANAGEMENT MODULE
575 MOBILITY MODULE
310 TRANSCEIVER CIRCUIT
330 ANTENNA
350 USER INTERFACE
370 CONTROLLER
390 MEMORY
410 OPERATING SYSTEM
430 COMMUNICATIONS CONTROL MODULE
450 CSI MODULE
510 TRANSCEIVER CIRCUIT
530 ANTENNA
550 CORE NETWORK INTERFACE
570 CONTROLLER
590 MEMORY
610 OPERATING SYSTEM
630 COMMUNICATIONS CONTROL MODULE
650 CSI MODULE
670 NES MODULE
710 TRANSCEIVER CIRCUIT
720 NETWORK INTERFACE
730 CONTROLLER
740 MEMORY
750 OPERATING SYSTEM
760 COMMUNICATIONS CONTROL MODULE

What is claimed is:

1.-31. (canceled)

32. A method performed by a mobile device, the method comprising:
receiving, from an access network node, report configuration information including a plurality of sub-configurations indicating at least one of:
spatial domain adaptation patterns each of which corresponds to a subset of available spatial elements configured by the report configuration information, or
power offsets each of which corresponds to a power offset value between a physical downlink shared channel (PDSCH) and a reference signal; and
performing a measurement of one or more reference signals; and
transmitting, to the access network node, a measurement report using a transition time specific to the plurality of the sub-configuration.

33. The method according to claim 32, wherein
each of the spatial domain adaptation patterns corresponds to a respective set of antenna elements for transmission of the one or more reference signals.

34. The method according to claim 32, wherein
each of the plurality of sub-configurations indicates respective reference signal resources.

35. The method according to claim 34, wherein
the report configuration information includes an index indicating at least one of the spatial domain adaptation patterns or the respective reference signal resources, and the method comprises:
receiving, from the access network node, downlink control information (DCI) comprising the index.

36. The method according to claim 35, further comprising:
receiving, from the access network node, information indicating a mapping between the index and at least one of:
one spatial domain adaptation pattern from the spatial domain adaptation patterns; or
one reference signal resource from the respective reference signal resources.

37. The method according to claim 32, wherein
the measurement report includes information indicating at least one of:
one or more spatial domain adaptation patterns which correspond to a measurement result included in the measurement report, or
one or more antenna numbers each of which correspond to one of the one or more spatial domain adaptation patterns.

38. The method according to claim 32, wherein
the measurement report includes at least one of:
a plurality of Channel State Information (CSI), or
a layer 1 (L1)-Signal to Interference plus Noise Ratio (SINR),
each of which corresponds to one of the plurality of the sub-configurations.

39. The method according to claim 38, wherein
the report configuration information includes information indicating a number of CSI/L1-SINR to be included in the measurement report, and
the measurement report includes the best CSI/L1-SINR of the number of CSI/L1-SINR indicated by the information.

40. The method according to claim 38, wherein
the measurement report includes:
information for a first CSI or SINR value, and
information for a second CSI or SINR value;
wherein the second CSI or SINR value is indicated by indicating a difference between the second CSI or SINR value and the first CSI or SINR value.

41. The method according to claim 40, wherein
the information for the second CSI or SINR value uses smaller bits than bits used for the information for the first CSI or SINR value.

42. The method according to claim 38, wherein
the measurement report includes:
information for a first CSI or SINR value corresponding to an energy saving configuration for transmission of the one or more reference signals, and
information for a second CSI or SINR value corresponding to a non-energy saving configuration for transmission of the one or more reference signals, and
the second CSI or SINR value is indicated by indicating a different between the first CSI or SINR value and the second CSI or SINR value.

43. The method according to claim 32, wherein
the one or more reference signal resources comprises at least one of:
one or more non-zero power (NZP) channel state information reference signal (CSI-RS) measurement resources;
one or more CSI interference measurement (IM) resources; or
one or more NZP CSI-RS resources.

44. The method according to claim 32, wherein
the report configuration information is included in at least one of:
network energy saving (NES) configuration information;
a channel state information (CSI) report configuration information;
radio resource control (RRC) reconfiguration information; or
a system information block.

45. The method according to claim 32, wherein
the one or more reference signals are respective channel state information (CSI)-reference signals (RSs), and
the report configuration information is included in a CSI report configuration.

46. The method according to claim 32, wherein
the report configuration information comprises at least one of:
information indicating a plurality of resources for measurement of a channel; or
information indicating a plurality of resources for interference measurement;
wherein each of the resources for measurement of a channel or the resources for interference measurement correspond to one of the plurality of sub-configurations.

47. The method according to claim 32, wherein
the measurement report comprises:
information for one or more channel state information (CSI); and
information indicating a set of energy saving configuration corresponding to each of the one or more CSI.

48. The method according to claim 32, wherein
a bit length of the measurement report corresponds to contents of the plurality of the sub-configurations.

49. A method performed by an access network node, the method comprising:
transmitting, to a mobile device, in a cell operated by the access network node, report configuration information a plurality of sub-configurations indicating at least one of:
spatial domain adaptation patterns each of which corresponds to a subset of available spatial elements configured by the report configuration information, or
power offsets each of which corresponds to a power offset value between a physical downlink shared channel (PDSCH) and a reference signal; and
transmitting one or more reference signals for measurement; and
receiving, from the mobile device, a measurement report using a transition time specific to the plurality of the sub-configuration.

50. A mobile device comprising:
at least one memory configured to store instructions; and
at least one processor configured to execute the instructions to:
receive, from an access network node, report configuration information including a plurality of sub-configurations indicating at least one of:
spatial domain adaptation patterns each of which corresponds to a subset of available spatial elements configured by the report configuration information, or
power offsets each of which corresponds to a power offset value between a physical downlink shared channel (PDSCH) and a reference signal; and
perform a measurement of one or more reference signals; and
transmit, to the access network node, a measurement report using a transition time specific to the plurality of the sub-configuration.

51. An access network node comprising:
at least one memory configured to store instructions; and
at least one processor configured to execute the instructions to:
transmit, to a mobile device, in a cell operated by the access network node, report configuration information a plurality of sub-configurations indicating at least one of:
spatial domain adaptation patterns each of which corresponds to a subset of available spatial elements configured by the report configuration information, or
power offsets each of which corresponds to a power offset value between a physical downlink shared channel (PDSCH) and a reference signal; and
transmit one or more reference signals for measurement; and
receive, from the mobile device, a measurement report using a transition time specific to the plurality of the sub-configuration.
